(19) United States
(12) Patent Application Publication
(10) Pub. No.: US 2015/0193819 A1
(43) Pub. Date: Jul. 9, 2015

(54) Targeting Content to Meeting Location

(71) Applicant: Lawrence Chang, Foster City, CA (US)

(72) Inventor: Lawrence Chang, Foster City, CA (US)

(73) Assignee: Google Inc.

(21) Appl. No.: 13/445,295

(22) Filed: Apr. 12, 2012

Related U.S. Application Data
(60) Provisional application No. 61/499,585, filed on Jun. 21, 2011.

(51) Int. Cl. G06Q 30/02; G06Q 10/10

(52) U.S. Cl. CPC G06Q 30/0252; G06Q 10/1095

(57) ABSTRACT

A computer-implemented method includes receiving, at a computing device, a request related to an event to be scheduled; providing for display an incomplete scheduling entry form to the user for the event to be scheduled; receiving, from the user and at the computing device, information that identifies one or more invitees for the event to be scheduled and a topic that corresponds to the even to be scheduled; and automatically providing one or more advertisements that are selected using the information provided by the user in the scheduling entry form.

### CROSS-REFERENCE TO RELATED APPLICATION

This application claims priority to U.S. Provisional Application Ser. No. 61/499,585, filed on Jun. 21, 2011, entitled “Location Targeting for Calendar Applications,” the entire contents of which are hereby incorporated by reference.

### TECHNICAL FIELD

This document relates to obtaining and placing information relating to a calendar software application.

### BACKGROUND

Many computer users schedule their lives around electronic calendars that map out, time wise, what they plan to be doing at different times of each day. Some of the events in a calendar take the form of meetings, or events that are associated in a calendar application with multiple attendees. Calendar applications may permit users to identify open conference rooms in which to schedule a meeting, but without identifying a particular room or address that may be relevant to content of the meeting. A person can also manually move between various applications and services to identify particular venues for meetings and openings in various users' schedules, and then schedule a meeting. Various on-line scheduling services, such as restaurant scheduling services, also maintain databases about various businesses and facilities, but again generally require a user to identify a particular facility without using contextual information about a meeting.

Under each of these approaches, it can be cumbersome to populate the “location” field for the event's calendar entry with an address of a business location. If a user does not know the name for a location (such as the name of a business whose facility the meeting will be at), the user will generally need to refer to a search engine, maps application, directory assistance, or personal referral to identify a suitable business for the event. If the user does know the name of the business or facility, the user may still have to refer to the same sources, to find the actual address of the business or facility. In both cases, the user needs to leave the calendar application to track down additional information, select and copy the information, switch back to the calendar application, and paste the information in the appropriate field.

### SUMMARY

This document describes systems and techniques for automatically adding information to fields in a calendar event, such as in a form for populating a calendar event. In a general sense, a calendar entry may include a number of fields, such as a topic for a meeting, invitees or intended attendees for the meeting, a time for the meeting, and a place for the meeting. When a user enters information for one or more of the fields, that entered information may be used to identify relevant information for others of the fields that correspond to the entered information. For example, a user may decide to set up a meeting with several friends, and may enter a meeting topic such as “lunch,” and also select the friends as invitees (or more specifically, prospective invitees) from a contact list. The user's device may then automatically use the topic, along with geographic location information about the invitees in order to identify an area that is common to the invitees (e.g., that is around a geographic “center of gravity” for all the invitees, or is centered on a spatial cluster of invitees), and to identify facilities in or near the area that are responsive to the topic.

In presenting information to the user who is setting up the meeting, or in generating electronic invitations to the meeting, the system may also select promotional information, such as text ads or other forms of ads, to be displayed to such users. For example, a query may be performed on an ads database for businesses that are around the location of the planned meeting and that have registered with an ad management system. Ads for such advertisers may be selected and included in presentations to the users (e.g., along the side of an e-mailed appointment invitation and along with driving directions that may be generated automatically before the time of the meeting), and may be selected both on the location of the meeting and on other factors. For example, advertisers may choose “lunch” as a keyword for triggering the display of their ads when they think they might have goods or services that would be useful for people who just met for lunch, such as a drug store or grocery store in the area that wants to interest one of the attendees in picking up essentials on their way back home or back to the office. Such ads may be shown to attendees when the topic of their meeting includes the word “lunch” or a similar term, or the meeting is scheduled to occur over the lunch hour. The ads that are shown to each attendee may be the same or may be different. An ad may be common across all the attendees, for example, where it is an ad for a restaurant that will give the group a discount if they hold their next lunch (e.g., in a week or a month) at the restaurant. The ads may be different for each attendee if they are directed to locations on paths that the attendees will follow in getting from the presumed prior locations (e.g., their work addresses for weekday meetings, and their home addresses for weekend meetings).

In appropriate circumstances and in appropriate manners, options may be provided to allow users to limit the manner in which information, including personal information, is used by such techniques. For example, users may be given an opportunity to be logged into a system or not logged into the system, where less personalization is provided when the user is not logged in. Similarly, users may employ “incognito” or similar modes in a web browser or other application. Also, mechanisms may be provided to users so that they can see the sort of information that a system has collected, and may choose to have such information collected or choose to have it not collected. For example, in certain implementations, it may be appropriate to provide users with the opportunity to view the types of information collected, and to permit users to opt in or opt out of various systems that may collect information. Also, the storage of information by the systems may, in certain circumstances, be limited to certain time frames, such as storing information only for a predetermined number of months. Moreover, information that is stored and/or provided to third parties may be aggregated prior to any sharing or otherwise anonymized or affected so as to remove personally identifiable information from the data. The particular approaches that are employed with respect to user data may vary depending on the type of data and the type of services being provided, recognizing that in some circumstances, such steps may limit the usability of such systems by a user. As some examples for the implementations in this disclosure, a user may decline to have their location information used in selecting the location of an appointment, or in selecting advertisements to be displayed by a system.

In one implementation, a computer-implemented method for automatically populating calendar information is disclosed. The method comprises receiving, at a computing device, a request related to an event to be scheduled; providing for display an incomplete scheduling entry form to the user for the event to be scheduled; receiving, from the user and at the computing device, information that identifies one or more invitees for the event to be scheduled and a topic that corresponds to the even to be scheduled; and automatically providing one or more advertisements that are selected using the information provided by the user in the scheduling entry form. The method can also include identifying whether one or more of the invitees has requested data protection, and limited an amount of data provided about an invitee who has requested data protection. Also, the one or more advertisements can be selected by matching locations for the one or more advertisements with a location for the event, or to paths between the location of the event and locations of the invitees. In some aspects, the location for the event is selected as a location that is central to at least multiple of the one or more invitees. Also, providing one or more advertisements can comprise providing one or more advertisements selected for a geographic location that is determined to be common to the invitees, or selected to match a subject that the user selects for the event.

In another implemention, a computer-implemented method is disclosed that comprises identifying, with a computer server system, information relating to an event that has been entered on a scheduling entry form by a user of a computing device; selecting one or more advertisements having information associated with them that matches information entered by the user in the scheduling entry form; and providing the one or more advertisements to the computing device or one or more other computing devices arranged for display with information about the event. Selecting the one or more advertisements can comprise identifying a location that is determined to be common to multiple invitees for the event, and matching the determined location to locations that correspond to candidate advertisements, or by matching a topic for the event that the user provided to advertising keywords that correspond to candidate advertisements. The method can also include receiving a selection of a first advertisement by the user, and causing a venue that corresponds to the selected advertisement to be set as a location for the event. Also, the method can include causing electronic invitations for the event to be sent to invitees identified by the user for the event, the invitations including information about the venue. Moreover, the method can comprise selecting one or more advertisements that match a geographic location of the venue, and causing the one or more advertisements to be displayed to the invitees.

The details of one or more implementations are set forth in the accompanying drawings and the description below. Other features and advantages will be apparent from the description and drawings, and from the claims.

### DESCRIPTION OF DRAWINGS

FIG. 1 is a conceptual diagram of a system for populating information for a calendar event.

FIGS. 2A and 2B are schematic diagrams of systems for populating information for a calendar event.

FIG. 2B is a block diagram of a server system for providing user assistance in electronically scheduling meetings and other appointments.

FIG. 3 is a flow chart of a process for identifying calendar event information that is responsive to partial event information entered by a user of a computing device.

FIG. 4 is a swim lane diagram of a process that shows example tasks performed by various components of a calendaring system.

FIGS. 5A and 5B are activity diagrams that shows actions performed in completing scheduling information for a user of a computing device.

FIGS. 6A-6J show example screen shots of a mobile computing device showing interaction with a calendar event entry form.

FIG. 7 shows an example of a computing device and a mobile computing device that can be used in connection with computer-implemented methods and systems described in this document.

Like reference symbols in the various drawings indicate like elements.

### DETAILED DESCRIPTION

This document discusses systems and techniques for providing information to users who are electronically scheduling meetings or other forms of appointments. For example, as a user enters information into certain fields of an appointment-generating form, other fields may be completed, or suggestions for them may be provided, for the user based on the information they have already entered. The system may automatically access information external to the appointment-generating application in order to supply such information. For example, the home locations or work locations of each of the invitees for a meeting may be identified (depending, e.g., on whether the meeting is during work hours or outside of work hours) from a contact list for the scheduling user, and a location for the meeting may be selected automatically based on such locations. For example, a location may be selected that is central to all of the users, or central to a plurality of the users, though not all the users, where the plurality of users is clustered in a close location and the other users are well outside that location. In addition, locations of users around the time of the meeting may be identified (which may include reference to travel information indicating that the users will be away from their home areas) to determine whether the meeting should be scheduled via a teleconference, and information for such a teleconference may be added to the meeting invitation automatically (including by selecting whether the teleconference should include video, depending on a determination of the teleconferencing capabilities of each of the invitees to the meeting).

Promotional information may also be displayed to users of such a system. For example, an ad and coupon or discount offer from a local restaurant may be displayed once a general geographic location for a meeting has been identified (e.g., in a zone that is central to the presumed locations of most of the attendees), and the person scheduling the meeting may see the offer and have information for the restaurant automatically added to the invite (e.g., the address and telephone number for the restaurant, as well as a hyperlink that each attendee may select to have a map of the area around the restaurant generated on their mobile computing devices and/or driving directions provided from their current locations to the restaurant). Other forms of ads may be shown after a location is selected, such as for stores that are near the meeting or along the routes for each respective user going to and from the meeting. As one example, coffee shop ads may be selected in real-time for each user after they leave a lunch or other meeting, under an assumption that they may want to get a coffee before they return to home or work. These ads may differ from local ads that would have been selected based only on the user's location, and not based on a recognition that the user just left a particular type of meeting. The advertisers may include keywords for having their ads selected, such as “lunch” to match a general meeting descriptor that a user may select, and “Asian” to match a more particular descriptor that the user may select, or that may be selected automatically by the system (e.g., by looking to profiles of the attendees to find favorite food types and exclude certain types—e.g., if a user indicates that they hate Asian-inspired food, they must have lactose-free food, or they have some sort of food allergy).

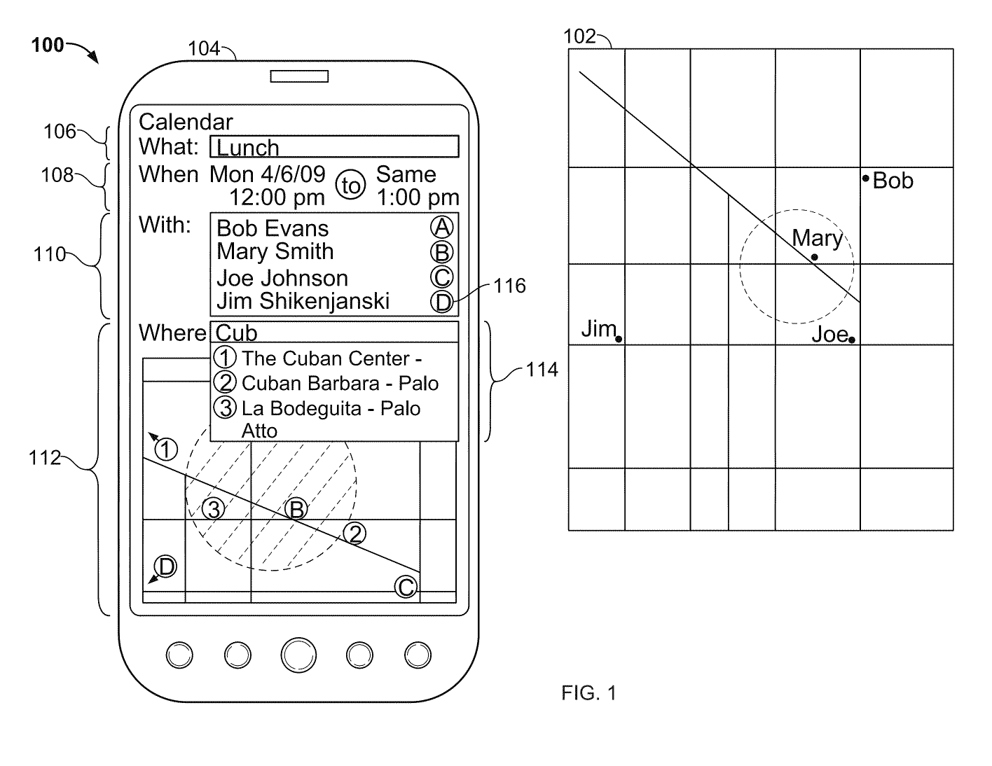

FIG. 1 is a conceptual diagram of a system 100 for populating information for a calendar event. In general, the system 100 shows a mechanism by which a user of a mobile computing device 104, such as a smart phone, may be provided with suggestions for completing the entry of data for establishing a meeting with one or more other users.

In the figure, the mobile computing device 104 is shown as displaying a graphical user interface of an appointment or meeting planning form. A map 102 of a location in a city is shown adjacent to the device 104 to indicate corresponding data for the entry of geographical information in the form. Referring now to the display on the device 104, a meeting input form is displayed on the device, with input fields 106-110, above an area entry zone 112 that includes a display of a geographic map. A topic field 106 displays a description regarding a topic of the meeting, which in this situation has been entered by a user to be “lunch.” The topic may have been typed in by the user, selected from a drop-down list of possible topics, or otherwise provided on the device 104. A timing field 108 indicates an intended time for the meeting. The time may be entered in manners that are familiar to users of calendar programs, such as by a user selecting a date from a calendar interface, and selecting corresponding time ranges using point and click inputs.

An invitee field 110 is shown below the timing field 108, and displays a list of users who have been invited to the meeting. The list may include the user of device 104 and/or may include additional invitees to the meeting. In this situation, four different other users have been invited to the meeting. The users may have been selected from a contact list for the user of device 104, or by other familiar mechanisms. In this example, each of the four listed users has been flagged with an icon of a letter in a circle, such as the icon with letter D, 116, for Jim Shikenjansky. As described next, the letters may correspond to icons in the map of the area entry zone 112, which show locations for those users (e.g., work or home addresses) so that a user may readily identify which invitee is located where on the map. (Note that the terms invitee and attendee are generally used here interchangeable under the assumption that the invitees in the examples will all attend the meeting.)

Referring now to the area entry zone 112, the user of device 104 has begun typing the name of a location for the meeting. In this instance, the user has typed the characters C, U, and B. The scheduling application on the device 104 has begun to provide suggestions for such entry, including the location of three restaurants that serve Cuban food. Various mechanisms for generating the suggestions may be provided, and may generally be served from a remote server system as the user types. In this example, the suggestions may have been influenced by the information entered in the topic area 106, so that the topic of lunch caused the application to focus on suggestions for restaurants. In contrast, if the user had entered the term “meeting,” and the invitees were all employees of one company at a single location, the device 104 may have displayed names for meeting rooms of the company at that location. Particular implementations for selecting locations of a meeting are discussed in more detail below.

As shown in the map in area entry zone 112, each of the invitees is displayed using their corresponding icons, and each of the three suggested restaurants is displayed using its corresponding icon. The map is centered on a general center of gravity for the users, and a zoom level is selected using various appropriate mechanisms so that an appropriate amount of the relevant data can be seen immediately on the map. At the location and zoom level, certain of the restaurants and users may be located off the edge of the displayed area, and are indicated by icons having accompanying arrows pointing in the direction of their actual location off the edge of the display. Also, a shaded circle is shown on the display to indicate a preferred zone for the meeting, as determined from the locations of the various users to attend the meeting. The user may be allowed to touch the map in order to zoom and pan to other areas, in a familiar manner.

Map 102 shows the relative locations of the four invitees to the meeting, where the user of device 104 in this example is Bob Evans. As can be seen from the map 102, three of the invitees are in one general area, while the fourth invitee, Jim, is located relatively far from the other invitees. Thus, the first three invitees can be said to be located in a cluster. Various known mechanisms may be used for identifying geographic clusters of items (e.g., invitees), and various appropriate values may be applied to such determinations (to identify thresholds for classifying a group as being or not being a cluster) so that the system 100 identifies clusters in a manner that corresponds to user expectations for such clustering. As noted above, particular users may choose to not share their location information, or may limit the manners by which such information is collected and/or used (e.g., by sharing it only with other users identified as their friends in a social networking system, by identifying their location only in broad terms, such as by zip code, and the like).

The use of clustering may be employed in selecting an area from which to identify locations for the meeting. In particular, if the invitees are relatively evenly dispersed, and not clustered, a location may be selected for the meeting that is near the center of gravity of all of the users, where each user may be given equal weight in making such a determination, or certain of the users, such as the user of device 104 may be given slightly additional weight so that the meeting tends to be located closer to them than to other users, as a reward for organizing the meeting. However, when a number of the users are located very closely together, and another user, such as Jim, is located very far away, it may not make sense to locate the meeting part way between the first three users and Jim. Instead, it may make more sense to locate the meeting at the center of gravity of the first three users who are in a cluster, and to require Jim to travel an additional length to attend the meeting. This may be particularly true if the user of device 104 has previously identified Jim as an optional attendee for the meeting.

Using the elements shown in the figure, Bob, the user of device 104 may select one of the three suggested restaurants, may enter additional characters in the “Where” field, may enter different characters in the field, or may make other adjustments to the information in the meeting request form. Once the information is set to Bob's liking, he may provide an input to the device 104 to send the meeting invite, and the system 100 may send the invite, such as by addressing individual emails to each of the invitees, where the emails include code for generating user-selectable controls for accepting the meeting or declining the meeting. Such subsequent interaction between the users may occur via well-known mechanisms. However, the interaction may also be supplemented, in that, for example, an invitee who does not like the meeting place may invoke the same features initially invoked by Bob, in order to identify an alternative meeting place that might be convenient for all or most of the invitees.

In this manner, the features discussed with system 100 may provide an intuitive and convenient mechanism by which to schedule meetings at times and in locations that are convenient to other users. The approaches can make use of common meeting scheduling user interface techniques, and may make use of publicly available hosted services for enriching such interactions.

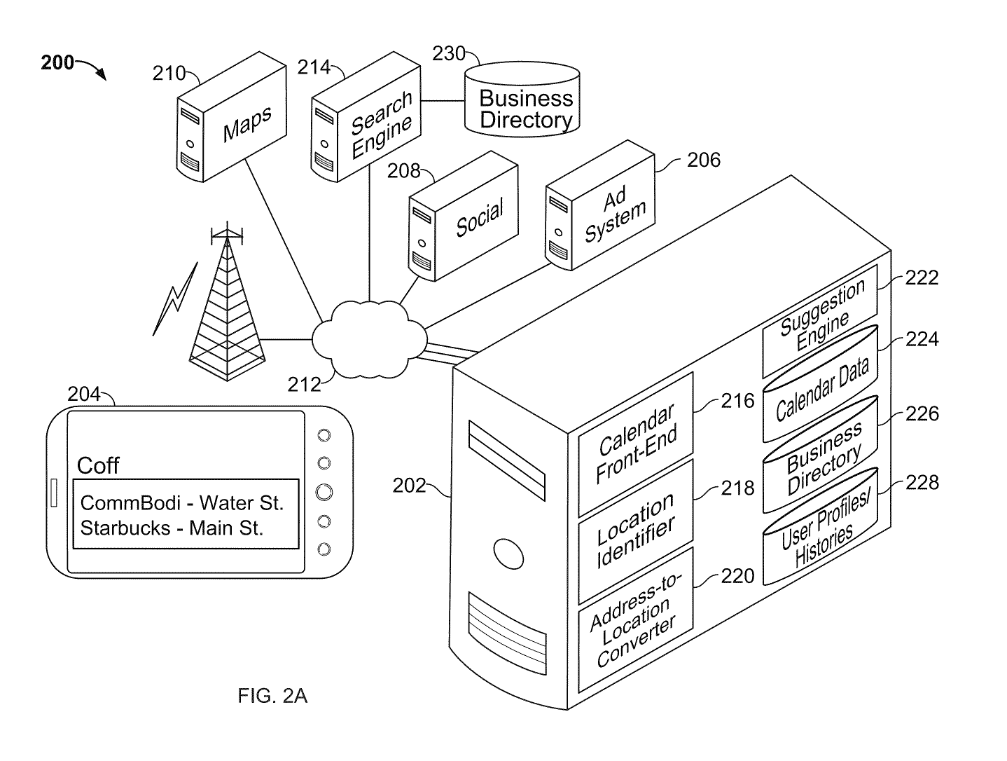

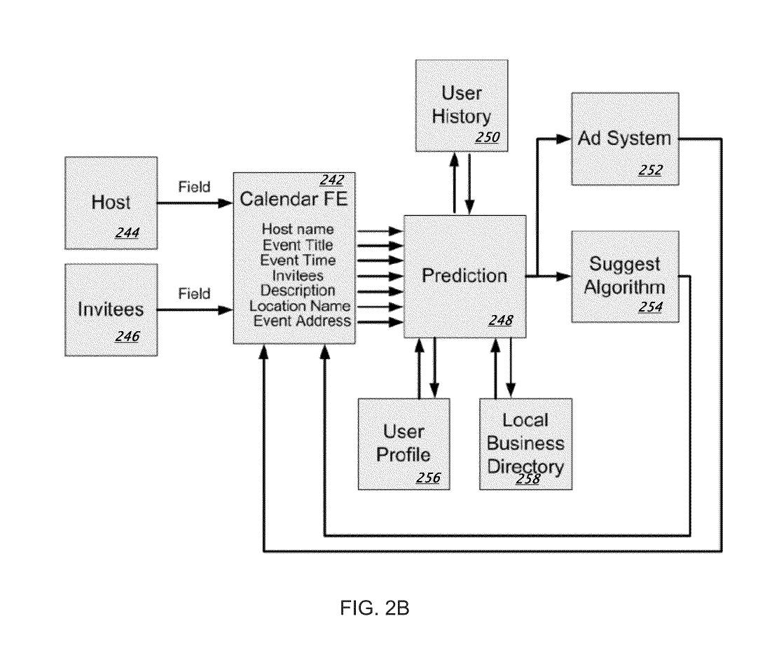

FIGS. 2A and 2B are schematic diagrams of systems for populating information for a calendar event. Referring to FIG. 2A, a system 200 is arranged to provide scheduling assistance similar to what is displayed with the device 104 in FIG. 1. Much of the system 200 in this example is shown as being implemented by various hosted services on a variety of server systems, but other arrangements may also be used, and additional functions may be executed on a client device such as mobile computing device 204. The particular structural components and functions discussed here are provided as an example, and additional or different features may be provided, and using different arrangements of components.

The system 200 generally operates by a user of mobile computing device 204 accessing a scheduling server 202 over a network 212, which may include the Internet and one or more wireless service provider networks. The services provided to mobile computing device 204 may span a wide variety of services, and in this particular example, may include providing suggestions or completions for entry of data into a form for scheduling a meeting with multiple invitees.

The scheduling server 202 is the centerpiece of the interactions in this example, and includes a number of components to assist a user of mobile computing device 204 in conveniently establishing a meeting or other form of appointment with one or more other users. For example, a calendar front end 216 may be provided and may be implemented using a Web server and other relevant components for serving code to mobile computing device 204, so that the mobile computing device 204 renders a user interface like that shown on the display of device 104 in FIG. 1. The code, for example, may be arranged to be displayed in a browser on mobile computing device 204, or as part of a scheduling application, or app, that is executing on mobile computing device 204. The code may take the form of markup code (such as code in the form of hypertext markup language (HTML)), JavaScript code, or other appropriate code for permitting a user to have convenient interaction with mobile computing device 204 in entering scheduling data.

A location identifier 218 may be provided to determine locations for the user of mobile computing device 204 and other users of the system 200, in addition to locations of venues at which a meeting may occur. For example, the location identifier 218 may receive information from the mobile computing device 204 or with a communication from the mobile computing device 204, such as global positioning system (GPS) data generated by the mobile computing device 204, cellular tower triangulation data generated by a network around the mobile computer device 204, or other appropriate information for locating a user of the mobile computing device 204. Alternatively, or in addition, the location identifier may identify a location for the user of mobile computing device 204 that is not the current location of the mobile computing device 204. For example, the location identifier 218 may determine a home or work location for the user of mobile computing device 204, where a meeting is being established that indicates that the user will be at a location other than their current location when the meeting occurs.

Also, a location identifier 218 may use similar mechanisms for identifying the locations of other invitees to a meeting. For example, if a user of mobile computing device 204 seeks to call an impromptu immediate meeting, the location identifier 218 may determine the current locations of other invitees to the meeting, including by using mechanisms like those discussed above. As one example, the location identifier 218 may refer to a service such as GOOGLE LATITUDE to identify the locations of other users, where such a service may take care of ensuring that the user of mobile computing device 204 should have access to such location information of other users. Moreover, the location identifier 218 may determine locations for venues at which a meeting is to take place. For example, where the name of a restaurant is provided to location identifier 218, the location identifier may provide a geographic location for that restaurant for use in establishing whether the restaurant would be an appropriate venue for a meeting of the users.

Address-to-location converter 220 is a service that may be called when a location is expressed in terms of a prose address what needs to be converted to a lat/long pair or similar coordinates for purposes of computing distances and relative locations of users, venues, and other objects in the system 200. Mechanisms for making such conversions are well-known and the particular techniques used are not critical here.

Suggestion engine 222 may be programmed to receive information that has already been entered by a user of mobile computing device 204 into a calendar scheduling application, and to provide suggestions based on such information. In particular examples discussed here, the suggestions are generally for locations at which to hold a meeting, though the suggestion engine 222 may also provide suggestions for a time of the meeting, including in familiar manners such as by showing stacked schedules for each of the invitees so that a user of mobile computing device 204 may readily locate a time that is open for all of the invitees. The suggestion engine 222 may also suggest additional users to be invited to a meeting, such as by making reference to social connections between users, including users who have already been invited to the meeting, by looking at topics for previous meetings that match a topic for the meeting that a user of mobile computing device 204 is planning, and by other similar mechanisms.

Calendar data 224 is a data store that keeps information regarding the calendars of various users of the system 200. The calendar data 224 may mirror data that is stored locally on the mobile computing devices of each of the users, and the two stored locations may be synchronized in familiar manners. The calendar data 224 may include individual appointments for particular users in addition to meetings between multiple such users. The calendar data 224 may specify fields, including the invitees or attendees for a meeting, a topic for a meeting, a place for a meeting, contact information where the meeting is to occur by teleconference or other electronic medium, and a time for the beginning and end of the meeting. In addition, the data may specify whether particular parameters will be part of an appointment, such as a need for whiteboard software or other similar information.

Business directory 226 stores information regarding various businesses and other venues at which meetings may be scheduled. For example, the business directory 226 may store profiles for different venues that include information about the type of business, such as whether it is a restaurant, coffee shop, or similar business, the size of the venue, the location of the venue, the hours that the venue is open, and other similar information that may be needed to allow the system 200 to automatically select or suggest the venue as the location for a meeting. Ordinarily, the business directory 226 would be hosted by a separate system from the calendar server system 202, and would be accessed over the network 212 by such a system.

User profiles/histories data store 228 includes information about the various users of the system 200. For example, the data store 228 may include information about the home and work addresses for the users, profile information about the likes and dislikes of the users, including favorite restaurant and types of food, and favorite coffee shops or other venues for holding meetings. Such information may be determined by analyzing venue reviews that the various users have provided to venues, such as by giving various venues 1 to 5 star ratings and written reviews. Such review information may be coordinated so as to select meeting locations at which multiple common invitees have had positive experiences. The data store 228 may also include history information that allows the system to select a venue for a meeting by identifying other meetings that involve the same or similar attendees, and selecting the same venue as those prior meetings, as long as there are no negative comments about the venue from the users that are accessible to the system.

Additional server systems are provided outside of the calendaring server system 202 to provide greater functionality for the overall system 200. For example, a maps server 210 may be used to generate graphical maps data for a display such as that on device 104 in FIG. 1. The maps server system 210 may be accessed in familiar manners, such as is well-known for services like GOOGLE MAPS. The maps server 210 may, for example, permit a third-party such as scheduling server 202, to specify particular venues and users, and have an interactive map generated that shows icons superimposed on the map for the venues and users, such as in the form of pins or other icons. In addition, the map may provide information about the particular icons when a user of a mobile computing device 204 selects one of the icons, such as an address description and telephone number for a restaurant, or a home or work address and contact information for another user.

Search engine 214 may be provided to respond to various calls from other components in the system 200. In this example, the search engine 214 has access to a business directory 230 which may be provided in addition to business directory 226 in calendar server system 202, or as an alternative to that directory. As one example, the search engine 214 may be provided with a keyword that describes a particular business, or a portion of a keyword such as the letters CUB in the example in FIG. 1. The search engine may then respond by providing information about businesses or other venues that match the full or partial query (e.g., by the business name or keywords for the business). Such information may be provided as actual search results or as suggestions in familiar manners.

A social server system 208 may be provided and accessed by other components of the system 200 to identify links of a social type between users of the system 200. For example, when a user enters full or partial names of invitees for a meeting, matching people in the user's local or hosted contact list may be searched, as may friends of the user identified by the social networking server system 208. Additional information about the users can also be identified, including home and work address information, current online status of the users (e.g., if they are logged in or not, so that they might be available for a chat session), and preferences such as preferences for certain types of food, restaurants, or other venues. Such information may be used by the system 200 to identified appropriate assumed locations for each user at the time of a scheduled meeting, and a preferred venue for holding the meeting.

An ad system 206 may be consulted by other components of the system 200 in order to select and serve targeted advertisements to users of the system 200. For example, when a user of device 204 is identifying a venue for a meeting, information about the invitees may be obtained in order to present a compelling promotion to the user. For example, if two of the invitees have indicated that they like Indian food, or that they like the New Delhi restaurant, an advertisement may be displayed to the scheduling user for that restaurant, overlaid with text that indicates to the user that the other two users have a positive view of Indian food or of the restaurant. If the scheduling user sets the meeting for that venue, the system 200 can register the action as a conversion and bill the restaurant that submitted the advertisement, in response to the indication of the conversion. Also, at the time of the meeting when users are opening the meeting reminder to obtain driving directions, the telephone number of the venue or other information, the ad server system 206 may provide them with advertisements for businesses around the place of the meeting, such as convenience stores where they can pick up milk or snacks on their way home or back to the office. Users may also be provided with mechanisms to prevent their personal information from being used in such manners, also. For example, some users may choose to fill out a profile that identifies their favorite foods, to have their calendar scanned to identify the types of food they often eat, or to have their restaurant reviews checked to identify their favorite restaurants, while other users may choose not to interact with such systems or to not have such systems checked for personalization information.

In this manner, the various structural components of system 200 may cooperate with each other to enrich a user's experience of setting a meeting, in a manner that allows the meeting to be scheduled at a time and location that tries to maximize the convenience to the users in total. The mechanisms may be made available through an intuitive interface such as a scheduling form, and can take advantage in certain implementations of information stored at a variety of systems, but without the user having to worry about such actions.

FIG. 2B is a block diagram of a server system for providing user assistance in electronically scheduling meetings and other appointments. In general, the system is similar to the system 200 discussed with respect to FIG. 2A, but focuses more closely on particular scheduling structures.

In the displayed system, a calendar front end 242 provides interaction with one or more users who are attempting to provide information for scheduling an event such as a meeting. For example, a meeting host 244 may be represented by a user who is currently entering information into fields of the calendar scheduling form that has been provided by the calendar front end 242, such as by serving markup language code and JavaScript code to a browser running on a device for the host 244. In addition, invitees 246 may provide information for helping to schedule a meeting. The particular information from the host 244 and invitees to 246 may be provided by those people directly, or may be obtained from files or data sources that reflect information about the particular users. For example, schedules for the various users may be consulted in known manners to identify a time at which multiple users are available to have a meeting.

The calendar front end 242 includes a number of fields that may be populated by a user or may be automatically populated by the system, or suggested by the system and selected from a group of suggestions by a user, such as the host 244. For example, the name of a host may be entered along with the name of invitees for a meeting. A title for an event or meeting may also be entered, as may a time or time range for the event. The location name may also be entered. For example, the host 244 can select a location such a conference room or restaurant from a map or from a textual list of venues, and a name of the venue may be automatically inserted into a location name field. Alternatively, the host 244 may start typing the name of a venue, and suggestions for a complete name may be provided, from which the host 244 may select. An event address may also be provided in a manner that is similar to that for providing the event name, such as by first identifying a location name and then performing a lookup on the location name to obtain an event address.

A prediction module 248 that receives input from the calendar front end 242 may take into account various pieces of information that have been entered into fields through the calendar front end 242 and make additional decisions regarding the desires of host 244 with respect to an event. The prediction module 248 may rely on a number of components in making such decisions, such as the user history 250. The user history 250 may include information about previous events to which invitees entered by the host 244 have gone, so as to elevate those locations above other locations when selecting a location for a meeting. Such a selection may be made under the assumption that, if a user has previously chosen or had an event at a particular location, then the location must be convenient to, and preferred by, the user.

A user profile 256 may also be consulted for similar purposes. For example, the user profile 256 may identify a location at which a user is likely to be when a particular meeting is held. The user profile 256 may also include information about the user's current schedule, including locations and times of other events, so that the system may select a venue so that each invitee can commute from other events to the selected event without being late. In addition, the user profile 256 may reflect the preferences of the user, such as preferences for particular meeting locations, types of venues, special needs such as requirements for handicap accessible venues, favorite types of food and similar information.

A local business directory 258 may be used to assist in selecting venues for events. For example, the directory 258 may list a plurality of businesses, along with metadata about the businesses, including labels, or keywords, that describe the type of goods or services provided by the businesses. As one example, a label of “Chinese cuisine” may be applied to a particular business, and may be used in matching that business as an event location to users whose user profiles 256 may indicate a preference for Chinese cuisine.

Two additional components receive outputs from the prediction module 248, and process those outputs to provide information to the calendar front end 242. An ad system 252, for example, receives keywords or other information from the prediction module 248, such as keywords that might indicate a preference of users for a Chinese restaurant. The ad system 252 may use such keywords to select advertisements from inventory of advertisements that were submitted by various advertisers. The selected advertisements may have their code provided to the calendar front end 242, which may then serve the code to the host device 244. In this manner, the advertisements selected by the ad system 252 may be targeted to the particular activity that the host 248 is trying to organize, and may thus have a higher likelihood of being selected and acted upon by the host 244, and in turn a higher likelihood of paying out for the organization running the system. As noted above, however, the host may choose not to have such information shared, in appropriate circumstances, though perhaps with an accompanying degradation in the performance of the system (e.g., the user may have to identify a restaurant on her own, or may miss out on receiving promotional items like coupons).

A suggest algorithm 254 is provided to process the various pieces of information received from the host 244, the invitees 246, the user history 250, the user profile 256, and the local business directory 258. Using the example discussed above, the suggest algorithm 254 may match information showing a preference in user profiles 256 for Chinese food, to a business that is listed as serving Chinese food, and that has been the location of meetings among some or all of the relevant invitees in the past, and/or that has received positive reviews from those invitees.

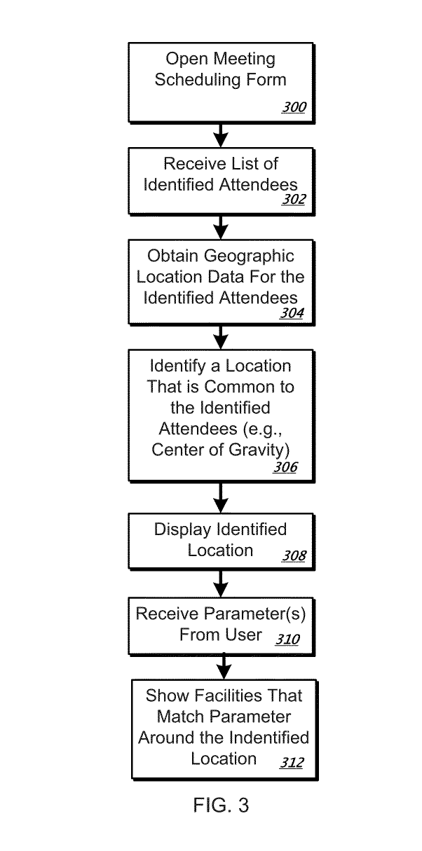

FIG. 3 is a flow chart of a process for identifying calendar event information that is responsive to partial event information entered by a user of a computing device. In general, the process describes interactions that a user of a mobile device, such as the mobile devices 104 in FIGS. 1 and 204 in FIG. 2, may undertake in scheduling a meeting that involves multiple invitees, or attendees, who are located at different locations. The process may, for example, provide suggestions or recommendations to the user as they enter information about the meeting that is planned, including by entering information into fields on a meeting scheduling form.

The process begins at box 300, where the user initially opens a meeting scheduling form. The form may initially be blank or may be partially filled in with default values, such as with the user being an invitee to the meeting, and with a default time for the meeting. At box 302, the process receives from the user a list of identified attendees. A user may provide that list in a variety of manners. For example, the user may type in the name of a pre-defined group of users, and each of the members of that group may be made automatically into invitees for the meeting. Alternatively, the user may select people from a contact list, such as a contact list on their computing device. Also, the user may type the names of invitees, and suggested other users may be shown as suggestions as the user begins typing each name, so that the user may then select another user as soon as they appear in a list.

At box 304, the process obtains geographic location data for the identified attendees or invitees. For example, the process may access a contact list for the user or a social network or similar service for the user. From those sources, the process may identify a home address for each of the other users, or a work address for each of the other users. The process may determine which address to use based on the time of the meeting or other event, such as on whether the event is to occur during normal work days and work hours or not. The information received for the invitees may be in the form of a textual address and may be converted to lat/long coordinates, or may be initially received in the form of lat/long coordinates.

At box 306, the process identifies a location that is common to the identified attendees. For example, the process may provide each of the locations for each of the associated attendees to a service that may compute a center of gravity or other common location for the attendees. Such a service may also perform clustering analysis to determine whether a certain subgroup of the attendees are very close to each other, so that the location should be selected within that cluster, even if the selected location is relatively far from one or more outlying attendees who are not in the cluster. Other mechanisms may also be used for identifying a location that is determined to be convenient or to provide maximum convenience for most of the attendees.

At box 308, the identified location is displayed to the user of the device. Such a display may involve showing a map on the device with the identified center of gravity displayed on the map, such as with a pin. In alternative implementations, the location need not be displayed to the user until after additional information and parameters have been entered by the user.

At box 310, such additional parameters are received from the user. Those parameters may include, for example, a time for the meeting, and a topic for the meeting. At box 312, the additional parameters and the identified location are used to identify one or more facilities or venues for a proposal for the meeting or other event. The facilities may be selected to match the one or more parameters, such as the topic. For example, the topic may relate to sports, food, bowling, or other similar events, and the system may determine a type of event from the topic, and then may use that event type to identify venues from a business database that are near the identified location. Such venues may then be displayed on the map or in other manners to the user, especially where there are multiple venues, so that the user may select one such venue to be included as a location for the meeting. The selection of a venue may also be set to match other parameters, such as a business that is large enough to accommodate the number of invited attendees. The user may then send a completed meeting invitation out to the other users and they may complete their acceptance or rejection of the meeting in a conventional manner. In addition, contact information may be provided to the first user for the venues, including click-to-call links, so that the user may confirm the availability and capabilities of the venue before identifying it on his or her device as the venue for the meeting.

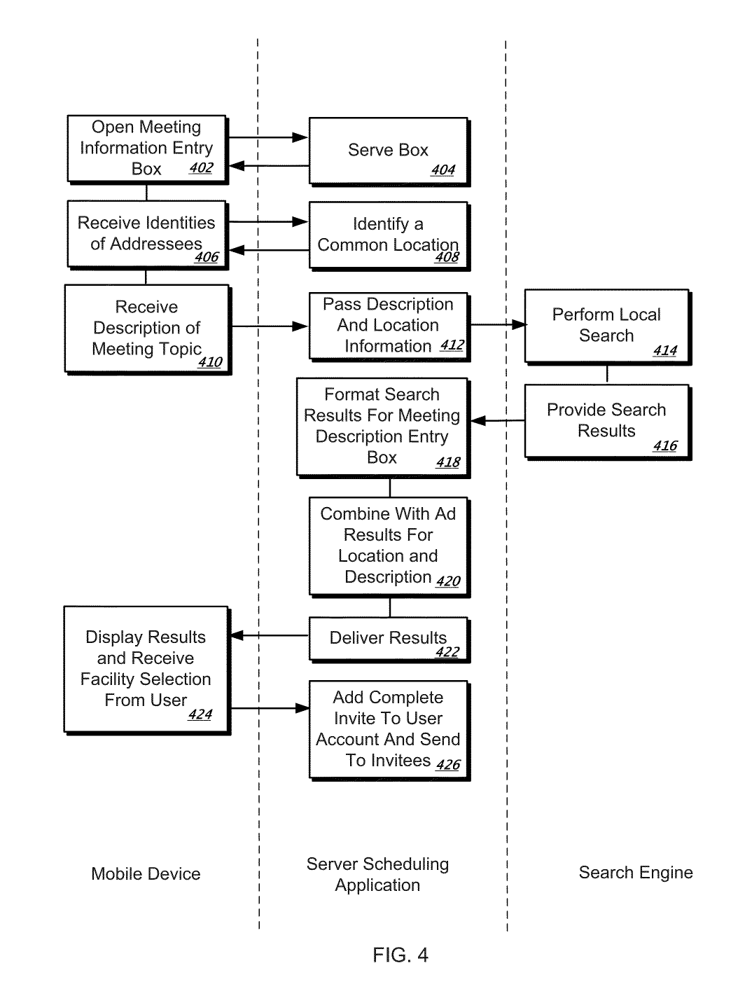

FIG. 4 is a swim lane diagram of a process that shows example tasks performed by various components of a calendaring system. In general, the process is similar to the process discussed for FIG. 3, but particular structural components in a system are shown to provide an example regarding how various tasks may be divided in providing assistance to a user in scheduling a meeting or other event.

The process begins at box 402, where a user opens a meeting information entry box on a graphical user interface of their computing device. Such an action by the user may cause a message to be sent to a server scheduling application, which may in turn serve code for generating the information entry box, at box 404. Such code may be delivered to a browser or app that may be executing on the computing device, which in certain implementations may be a mobile computing device such as a smart phone.

At box 406, the computing device receives identities of the addressees, or invitees, for the meeting from a user of the computing device. Various manners for entering and determining invitees are discussed in detail above and below. At box 408, the server scheduling application identifies a common location for the addressees, where the location is determined to match base locations for each addressee at the time when the meeting is expected to occur, so that the location of the meeting is convenient to attend for most or all of the addressees. Such a location may then be displayed to a user of the computing device, such as on a graphical display of a map.

At box 410, the process receives a description of the meeting topic from the user of the computing device, such as in manners discussed above. The server scheduling application then receives that description and passes the description and the previously-identified location information, at box 412, to a search engine. The search engine may be a publicly available search engine that operates according to a published application programming interface (API), where the interface may define that the search engine may receive search query terms, and a corpus identifier, among other information. The corpus identifier may be used to identify the source of search results that the requesting application would like to receive from the search engine, such as Web results, image results, product shopping results, or business listing results, among others.

The search engine then, at box 414, performs a local search around the identified location and using the topic submitted by the server scheduling application. For example, the search engine may perform a search around a lat/long coordinate using the keyword “Chinese restaurant.” The search engine may then provide the search results back to the server scheduling application, at box 416.

At box 418, the server scheduling application formats the search results for the meeting description entry box, such as by providing code for displaying a map having pins for each venue identified by the search engine overlaid on the map, where a user selection of a pin may show the user additional information about each of the venues. An example of such display is provided by services such as GOOGLE MAPS. At box 420, the server scheduling application additionally combines ad results that are targeted to the location and the description. For example, one of the identified venues may have placed an advertisement that offers a discount for customers, and that advertisement may be displayed to the user who is scheduling the meeting, so as to improve the chances that the particular restaurant will be selected. (And as noted above, the user may prevent the sharing of information that would enable the selection of particularly relevant advertisements.) The restaurant could, for example, indicate that all users who schedule using a certain system will receive a particular discount on a meal at the restaurant. At box 422, the server scheduling application then delivers the results, such as in the form of markup code or other similar code to be displayed in a browser or on mobile device or other computing device.

At box 424, the computing device displays the results that are received, and in turn receives from the user a facility selection. For example, the user may select a particular facility provided in a list or that is provided as a pin on a map, to indicate that they would like to have the meeting scheduled for that facility. When the user has confirmed that the meeting information is correct, which they may do in a conventional manner, the computing device sends such confirmatory information to the server scheduling application, which in turn (box 426) stores such information in a file directed to the user's account, and also causes meeting invitations to be sent to the identified attendees for their confirmation or declining of the meeting.

At various points in the process described here, advertisements may be displayed to the initial user or to other invitees. For example, after the user has entered the identities of the addresses at box 406, and/or after the user has entered a description of the meeting topic, advertisements may be selected by a server-based advertising system that is operated by the same organization that operates the server scheduling application. Where the user has only entered information about addressees, the central location may be used as a match for selecting ads from an inventory of ads that have been submitted by various advertisers (which may include the advertisers themselves or placement agents working on behalf of the main advertisers). When the user has entered a meeting topic, the advertisements may be selected to match the topic. For example, if the topic is “lunch,” advertisements that have been submitted with a keyword of “lunch” or “restaurant” or a similar term may be candidates for selection and serving to the initial user.

In such a situation, the user may select one of the advertisements, may review resulting information about the particular business or venue, and may select an on-screen control to “book” the business for the appointment. If the business is a restaurant that takes reservations, such a step may cause a message to be sent to the business (e.g., through a service such as Open Table) making the reservation with other information known to the process (e.g., the number of attendees and the last name and telephone number for the first user). Such a step may also result in information about the business being added automatically to the record for the meeting, including text for the address and telephone number for the business, and a hyperlink that the invitees may click in order to have a map and/or turn-by-turn driving directions generated on their own devices for them (e.g., when they receive a meeting reminder just before the meeting, they may click to open the meeting record, and may click a hyperlink to have the map of directions generated for them).

As noted, other advertisements may be selected after a meeting place is selected. For example, if the first user places the meeting at a restaurant that serves hot food, the invites and other advertisements selected for the attendees before or after the meeting may be from advertisers who used related keywords, such as ads for antacid, for drug stores, and for bottled water, among other things. For example, certain types of businesses may be associated with the term “heartburn,” even where that term was not selected by the businesses themselves, and various advertisers may select that word as a keyword for their advertisements. In this manner, particular useful advertisements may be selected, and user satisfaction with the system may be improved. Also, the organization that provides the scheduling software and service may be compensated for its effort and may use such compensation to improve the service and develop additional such services.

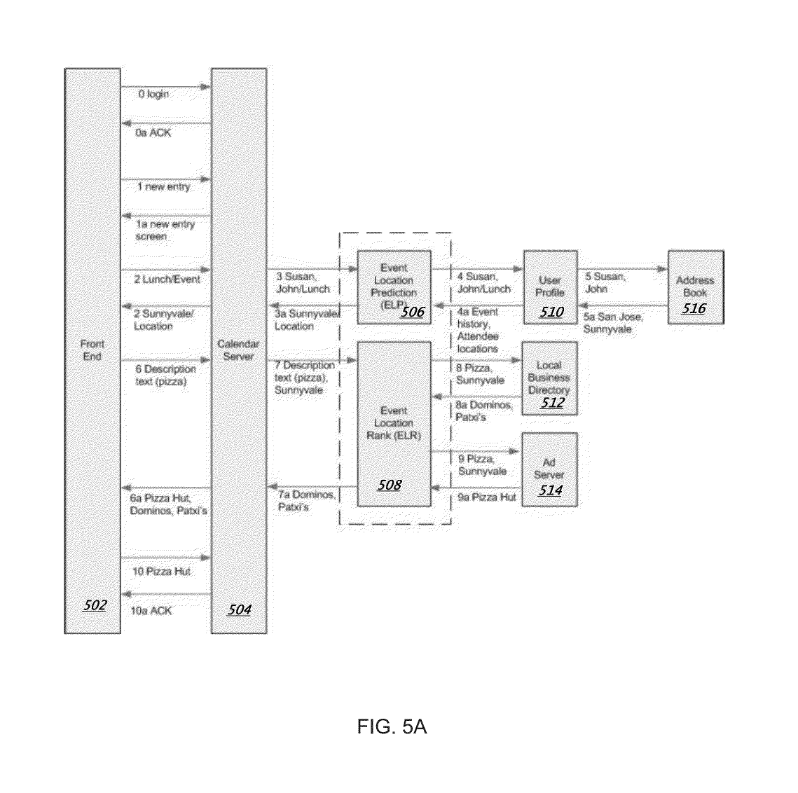

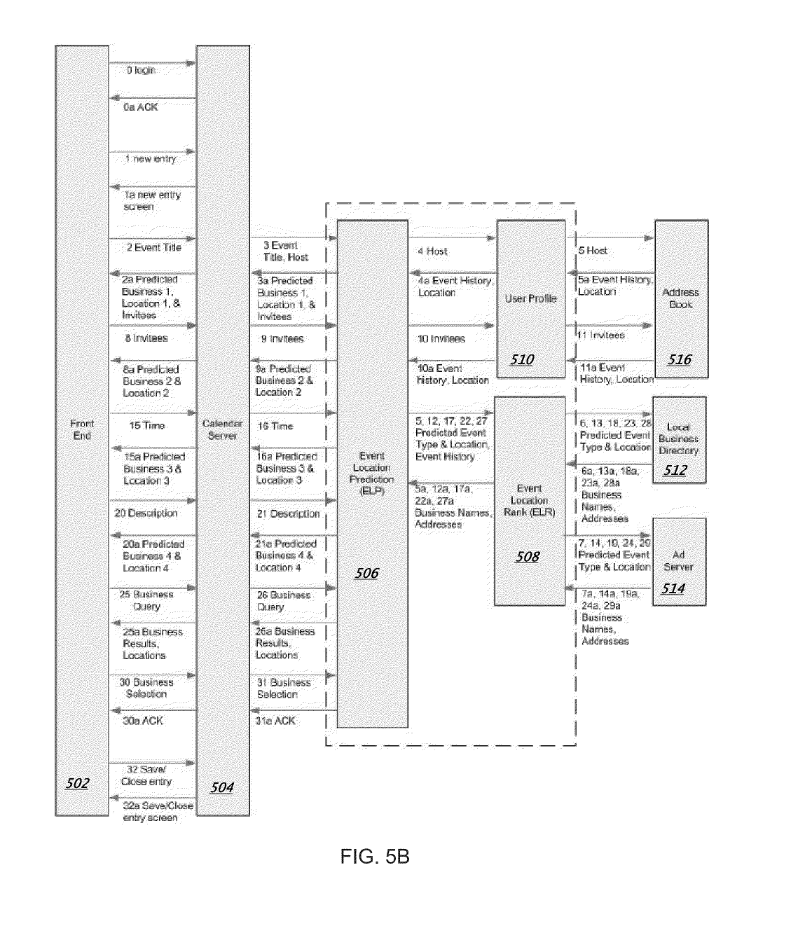

FIG. 5A shows an activity diagram of actions performed by a system 500 in completing scheduling information for a user of a computing device. For example, the actions can be performed by a system that includes the mobile device 104 shown in FIG. 1 or by the system 200 shown in FIG. 2A. The diagram shows server-side interactions for a cloud based calendaring system that occur, for example, when a user sets up a meeting request. The system 500 includes a front end 502, which can be, for example, a calendar application running on a computing device, such as a mobile phone, PDA, or personal computer, or a web server for generating code to be delivered to such an application. The front end 502 can include a GUI for interacting with a user. As an example, the actions of the front end 502 can be performed by the mobile device 204 shown in FIG. 2A. As another example, the front end 502 can be the calendar front end 216 shown in FIG. 2A. As yet another example, the front end 502 can be the calendar front end 242 shown in FIG. 2B.

The system 500 further includes a calendar server 504 for interacting with the front end 502 and providing predictive suggestions for field values of calendar fields displayed by the front end 502. The system 500 additionally includes an event location prediction module (ELP) 506 for predicting potential geographic locations for a meeting and an event location rank (ELR) module 508 for determining specific location suggestions for a meeting, and ranking the location suggestions in order to determine one or more best suggestions. For example, the functions of the ELP module 506 can be performed by the address-to-location converter 220 shown in FIG. 2A. As another example, the functions of the ELR module 508 can be performed by the suggestion engine 222 shown in FIG. 2A or the prediction module 248 shown in FIG. 2B. In some implementations, the ELP and ELR modules 506 and 508 are co-located. In some implementations, the functions performed by the ELP and ELR modules 506 and 508 are performed by one module.

The system 500 further includes a user profile module 510 and an address book 516 that store information that can be used by the ELP module 506 to determine one or more suggested locations for a meeting. For example, the user profile module 510 can be the user profiles/histories database 228 shown in FIG. 2A or the user history data 250 shown in FIG. 2B. As another example, the address book 516 can be included as part of the user profile/histories database 228 shown in FIG. 2A. The user profile module 510 stores information about a meeting host and meeting invitees, such as eating preferences, schedule information, and historic meeting information. The address book 516 stores address and contact information for the meeting host and invitees. For example, the address book 516 can store home and work addresses, telephone numbers, and e-mail addresses for the host and invitees. In some implementations, the user profile module 510 and address book 516 can also be accessed by the ELR module 508 to be used when determining specific suggested locations for a meeting.

The system 500 additionally includes a local business directory 512 and an ad server 514. For example, the local business directory can be the business directory 230 or the business directory database 226 shown in FIG. 2A. As another example, the local business directory 512 can be the local business directory 258 shown in FIG. 2B. As yet another example, the ad server 514 can be the ad system 206 shown in FIG. 2A or the ad system 252 shown in FIG. 2B. The local business directory 512 includes information about local businesses, including address information, contact information, business category information (e.g. restaurant, shoe store, coffee shop), business description information, customer rating information, customer reviews, and availability information (e.g. does a particular restaurant have reservations available for a given time). The ad server 514 can provide targeted advertising content based on predictive information and contextual information provided by the user using the GUI provided by the front end 502.

Turning now to a specific example, a meeting host starts a calendar application. Upon initiation of the calendar application, the front end 502 sends a login request to the calendar server 504. The calendar server 504 returns an acknowledgement to the front end 502 in order to initialize a session. The meeting host then indicates a desire to make a new calendar entry by, for example, selecting a new entry icon or by pressing one or more keys on a keyboard. The front end 502 sends a new entry request to the calendar server 504 which in turn provides a new entry screen to the front end 502 for presentation to the meeting host. For example, the new entry screen can be the calendar entry display shown on the mobile device 104 in FIG. 1.

The meeting host can populate fields of the new entry screen to indicate that the new calendar entry is a meeting request for lunch, and that meeting invitees include Susan and John. The front end 502 provides some or all of this information to the ELP module 506. For example, the calendar server 504 can indicate that Susan and John are invitees for this meeting without indicating the description of the event (i.e. “Lunch”) or a time for the meeting. As another example, the calendar server 504 may provide the ELP module 506 with all relevant information for the meeting, including the identity of the meeting host and the description. As another example, the meeting host may have indicated a specific time for the meeting and this information can be provided to the ELP module 506.

The ELP module 506 uses the information provided by the calendar server 504 to determine one or more suggested geographic locations for the meeting. The suggested geographic locations may take the form of a city, a neighborhood, a borough, an intersection, a zip code, an address, or any other geographic area. For example, the ELP module 506 can access the user profile module 510 to retrieve address information for the invitees and the meeting host. In some implementations, the ELP module 506 provides time information to the user profile module 510 so that a most likely location for each of the invitees and the meeting host can be determined. In the example shown, the ELP module 506 can determine that since the title of the meeting is “Lunch” that day time addresses for each of the meeting attendees should be identified. In this example, the ELP module 506 can determine that the day time addresses for each of the attendees are the work addresses for each of the attendees. The ELP module 506 can then request work addresses for each of the attendees from the user profile module 510. As another example, if the meeting host provides a specific time for the meeting, the ELP module 506 can access schedule information stored by the user profile module 510 for each of the attendees to determine which address for each attendee should be used. For example, if the meeting host indicates a meeting time of 5:00-5:30, the ELP module 506 can access schedule information for the attendees and determine that the meeting host and Susan generally work until 6:00, and therefore work addresses should be used for each of them. The ELP module 506 can further determine that John finishes work at 3:00 and therefore a home address for John should be used. As another example, the ELP module 506 can access John's scheduling information to determine that John has scheduled to go to the gym from 4:00-5:00. The ELP module 506 can then retrieve an address for John's gym from the user profile module 510.

In some implementations, some or all of the address information included in the user profile module 510 is populated using an address book 516. For example, the address book 516 can be a contacts list stored on the meeting host's mobile device that includes address information for each of the invitees. In the example shown, the user profile module 510 provides the names “Susan” and “John” to the address book 516, which returns addresses in San Jose and Sunnyvale to the user profile module 510. As another example, the address book 516 can be a store of white pages or yellow pages information. For example, the user profile module 510 can access a white pages listing for Susan using Susan's full name in order to determine an address for Susan. As another example, the address book 516 can be a company directory. The directory can include home and work addresses for employees, customers, vendors, and contractors. In some implementations, the user profile module 510 may access the local business directory 512 in order to identify information to associate with a user. Following the example where the ELP module 506 requests the address for John's gym, the user profile module 510 may use the name of John's gym to identify an address for the gym using the local business directory 512.

Still referring to FIG. 5A, the user profile module 510 provides location information, event history information, and preference information to the ELP module 506. The ELP module 506 can use this information to determine a suggested general location for the meeting. In the example shown, the ELP module 506 uses location for the meeting attendees to determine that Sunnyvale is a geographically central location for all three meeting attendees. The ELP module 506 then provides this suggested general location to the calendar server 504. As another example, the ELP module 506 can use historic meeting data associated with the attendees to determine that when the meeting host and John hold lunch meetings, the meetings are held in a specific conference room 90% of the time. The ELP module 506 can select this conference room as a suggested general location and provide the suggested general location to the calendar server 504. As another example, the applied weighting factors to address information associated with each of the attendees, or disregard information associated with one or more of the attendees. For example, if the meeting host is a sales representative and the invitees are customers, the ELP module 506 may ignore the location of the meeting host or give greater preference towards the locations of the invitees.

In some implementations, rather than address information, the ELP module 506 may use GPS information associated with the meeting host and/or the invitees in order to determine a suggested general location for the meeting. This can be especially useful if the meeting is scheduled to occur soon. For example, if the current time is 8:40 am and the meeting is scheduled for 9:00 am-10:00 am, the ELP module 506 can use GPS or other positioning data received from the meeting host's mobile device rather than an address associated with the meeting host in order to determine a suggested general location for the meeting. As another example, one or more of the invitees may share GPS data with the meeting host (e.g. by using a GPS sharing/networking application). The ELP module 506 can receive this GPS information for the one or more invitees and use the information when selecting a suggested general location.

Upon receiving one or more suggested general locations for the meeting from the ELP module 506, the calendar server 504 provides the one or more suggested general locations to the front end 502. The front end 502 can then present the one or more suggested general locations to the meeting host. For example, the front end 502 can automatically populate a location field of the calendar entry screen with a suggested general location. As another example, the front end 502 can display a dropdown menu near the location field that includes multiple suggested general locations. The meeting host can then select one of the suggested general locations to populate the location field, or enter a location into the location field that is different from the suggested general locations.

In the example shown, after the front end 502 has received the suggested general location of “Sunnyvale” and displayed the suggested general location to the meeting host, the meeting host enters a description for the meeting of “pizza” which the front end 502 then provides to the calendar server 504. The calendar server 504 provides the description information (“pizza”) and the general location information (“Sunnyvale”) to the ELR module 508. The ELR module 508 uses the provided information to select one or more suggested specific locations for the meeting. For example, the ELR module 508 can use the description of “pizza” to identify one or more restaurants to suggest for the meeting. As another example, if the description includes work related text (e.g. “presentation,” “work,” “revise”) a conference room can be suggested as a specific location for the meeting. Following this example, if the description includes the phrase “watch video,” a conference room that is equipped with a video projector can be suggested as a specific location. In some implementations, additional information is provided to the ELR module 508, such as the identities of the meeting host and invitees, or the title of the meeting (e.g. “Lunch”).

In some implementations, the ELR module 508 may need to process the description data in order to identify one or more keywords. For example, if the description is “Who's up for pizza?” the ELR module 508 can determine that “pizza” is a relevant keyword and that the words “Who's,” “up,” and “for” are not useful for determining a suggested specific location. As another example, the ELR module 508 can use a description of “I'm up for something light” combined with a meeting title of “Lunch” to determine that keywords of “salad,” “low-calorie,” or “light” and “food” are relevant to the meeting.

In some implementations, the ELR module 508 can access the user profile module 510 in order to base selection of a suggested specific location on information specific to the meeting attendees. For example, historic profile data for the meeting host can indicate that when the meeting host schedules meetings in Sunnyvale that involve pizza, the meeting host usually eats at a particular restaurant. As another example, historic profile data can indicate that when the three meeting attendees meet for lunch, they always go to the same sports bar. As yet another example, historic profile data can indicate that John always accepts meetings that occur at Domino's Pizza and never accepts meetings that occur at Pizza Hut.

Still referring to FIG. 5A, the ELR module 508 provides general location information and keyword search information to the local business directory 512 which can return potential specific locations. The local business directory 512 can be, for example, a yellow pages service, a search engine, a restaurant specific database, or other type of business directory. In the example shown, the ELR module 508 provides a search term of Pizza and a location of Sunnyvale to the local business directory 512. The local business directory 512 returns potential specific locations of Domino's and Patxi's. In some implementations, the local business directory 512 can return a large number of results to allow the ELR module 508 to select best results from the returned results.

In some implementations, the local business directory 512 provides additional information associated with potential specific locations that can be used by the ELR module 508 to rank the potential specific locations and select the highest ranked potential specific locations as suggested specific locations. This information can include business category information (e.g. restaurant, shoe store, coffee shop), business description information, customer rating information, customer reviews, and availability information (e.g. does a particular restaurant have reservations available for a given time). For example, the ELR module 508 can give a higher rating to results associated with higher customer ratings. As another example, the ELR module 508 can exclude a restaurant that has no available reservations for the meeting time as specified by the meeting host. In some implementations, the ELR module 508 uses historic user profile data to apply rankings to potential specific locations. For example, if the meeting host schedules a large number of meetings at Patxi's but does not schedule many meetings at other pizza places, Patxi's can be given a higher rating.

In some implementations, in addition to retrieving potential specific locations from the local business directory 512, the ELR module 508 contacts the ad server 514 in order to receive one or more paid advertisements to present to the meeting host. For example, the advertisements can sponsor potential specific locations for the meeting. An advertiser can pay to have a particular listing included in the one or more suggested specific locations provided to the meeting host. The ad server 514 can select one or more relevant advertisements to provide to the ELR module 508 based on targeting information provided by ELR module 508. In the example shown, the ELR module 508 provides the ad server 514 with a location of Sunnyvale and a keyword of “Pizza.” The ad server 514 can identify a sponsored potential specific location of “Pizza Hut” and provide the sponsored potential specific location to the ELR module 508.

The ELR module 508 selects one or more suggested specific locations from the potential specific locations provided by the local business directory 512 and the sponsored potential specific locations provided by the ad server 514. For example, the ELR module 508 can assign ratings to the potential specific locations as described above and select the two highest ranked potential specific locations as suggested specific locations. The ELR module 508 can then identify a sponsored potential specific location provided by the ad server 514 as an additional suggested specific location. The ELR module 508 provides the selected suggested specific locations to the calendar server 504 which in turn provides the suggested specific locations to the front end 502 for presentation to the meeting host. For example, the front end 502 can automatically populate a specific location field of the calendar entry screen with a highest ranked suggested specific location. As another example, the front end 502 can display a dropdown menu near the specific location field that includes multiple suggested specific locations. In some implementations, the sponsored potential specific location selected as a suggested specific location is marked as being an advertisement. The meeting host can select one of the suggested specific locations to populate the specific location field, or ignore the suggested specific locations by manually entering a specific location into the specific location field that is different from the suggested specific locations.

Once the meeting host has selected a suggested specific location or entered a value for a specific location, the front end 502 informs the calendar server 504 of the meeting host's indication. In the example shown, the meeting host selects Pizza Hut. The front end 502 then informs the calendar server 504 of the meeting host's selection and provides an acknowledgement to the front end 502. Upon completion of these actions, the meeting request can be saved to the meeting host's calendar and meeting requests can be sent to the invitees.

FIG. 5B shows an activity diagram of actions performed by a system 550 in completing scheduling information for a user of a computing device. For example, the actions can be performed by a system that includes the mobile device 104 shown in FIG. 1 or by the system 200 shown in FIG. 2A. The diagram shows server-side interactions for a cloud based calendaring system that occur, for example, when a user sets up a meeting request. The system 550 includes the same components as the system 500 of FIG. 5A arranged in a slightly different manner in order to show a more generalized example of interactions between the various components. For example, in the system 550, the ELP module 506 communicates directly with the ELR module 508 rather than the ELR module 508 communicating directly with the calendar server 504. In some implementations of the system 550, the ELP module 506, the ELR module 508, and the user profile module 510 can be co-located. In some implementations, the functions performed by these three modules can be performed by a single subsystem. The dashed box shown in FIG. 5B can indicate a potential separation of functions for different server subsystems.

In the example shown, a meeting host starts a calendar application. Upon initiation of the calendar application, the front end 502 sends a login request to the calendar server 504. The calendar server 504 returns an acknowledgement to the front end 502 in order to initialize a session. The meeting host then indicates a desire to make a new calendar entry by, for example, selecting a new entry icon or by giving a new entry voice command. The front end 502 sends a new entry request to the calendar server 504 which in turn provides a new entry screen to the front end 502 for presentation to the meeting host. For example, the new entry screen can be the calendar entry display shown on the mobile device 104 in FIG. 1.

The meeting host then enters an event title using the GUI provided by the front end 502. For example, the meeting host can enter a title of “Monday Night Football.” As another example, the meeting host can enter a title of “Meet at the Gym?” As yet another example, the meeting host can enter a title of “Let's meet up.” The front end 502 provides the event title entered by the meeting host to the calendar server 504. The calendar server 504 then provides the event title and an indication of the meeting host to the ELP module 506. For example, the calendar server 504 can indicate the meeting host using the meeting host's name, screen name, telephone number, e-mail address, or a user ID associated with the meeting host.

In the example shown, the ELP module 506 attempts to predict a location for the event by sending the indication of the meeting host to the user profile module 510 in order to receive location information associated with the meeting host. In the example shown, the user profile module 510 provides the indication of the meeting host to the address book 516 in order to receive location information and event history information associated with the meeting host. In some implementations, the user profile module 510 stores event history information and only receives location and/or contact information from the address book 516. The event history information can include information derived from past meeting events that have been initiated by the meeting host or for which the meeting host was an invitee. For example, the event history information can include a list of all locations where the meeting host has attended meetings, and the number of times the meeting host has attended meetings at the locations. The event history information can further include dates and times that the meeting host attended meetings at given locations, or other attendees for the meetings that the meeting host attended at given locations.

The user profile module 510 provides the event history information and location information associated with the meeting host to the ELP module 506. The ELP module 506 uses the information to predict values for one or more fields of the calendar application. In the example shown, the ELP module 506 uses the information to select a suggested general location, a suggested specific location, and suggested invitees for the meeting. For example, the ELP module 506 can identify a home address for the meeting host as being in Berkeley, Calif. The ELP module 506 can then select Berkeley as a suggested general location. As another example, the ELP module 506 can use event history information to determine that a large percentage of meetings initiated by the meeting host occur in San Jose, Calif. The ELP module 506 can use this information to select San Jose as a suggested general location. The ELP module 506 can additionally use event history information to select suggested invitees and a suggested specific location (e.g. a predicted business). For example, if 40% of the meeting host's meetings also involve Ron and David, the ELP module 506 can identify Ron and David as suggested invitees. As another example, if 30% of the meeting host's meetings occur in conference room D, the ELP module 506 can select conference room D as a suggested specific location. As another example, the ELP module 506 can use the event history information for the meeting host to determine that the meeting host eats at Capital Grill once per week, and hast not eaten at Capital Grill yet this week. The ELP module 506 can use this information to identify Capital Grill as a suggested specific location/predicted business.

The ELP module 506 provides the predicted values for the calendar application fields to the calendar server 504 which then provides the values to the front end 502 for presentation to the meeting host. For example, the front end 502 populates the calendar application fields associated with the predicted values. In the example shown, the front end 502 populates a specific location field with a predicted business, a location field with a suggested general location, and an invitee's field with the predicted invitees. The meeting host can elect to select any of the suggested predicted values, or to ignore the suggestions by entering other values. In the example shown, the meeting host indicates a number of invitees for the meeting. The front end 502 then indicates the invitees to the calendar server 504. For example, the front end 502 displays a list of five suggested invitees for the meeting. The meeting host selects two of the suggested invitees to be included as invitees for the meeting and manually enters values for two additional invitees. The front end 502 then indicates the four invitees to the calendar server 504.

The ELP module 506 uses the updated invitee information to provide a refined predicted business and predicted general location to the calendar server 504. In the example shown, the ELP module 506 provides indications of the invitees to the user profile module 510. The user profile module 510 then provides the invitee information to the address book 516 which returns event history information and location information associated with each of the invitees to the user profile module 510 which provides this information to the ELP module 506. For example, the ELP module 506 receives home, work, and other address information associated with each of the invitees. The ELP module 506 additionally receives event history information associated with each of the invitees based on past meetings and calendar events. In some implementations, only event history information for events in which both the meeting host and a given invitee were involved is provided to the ELP module 506. In other implementations, event history information for events involving a given invitee in which the meeting host was not involved is also provided. For example, the user profile module 510 may be able to access a company calendar database that includes event history information for one or more of the invitees.

The ELP module 506 uses the event history information and location information for the invitees to predict values for calendar application fields for which the meeting host has not yet assigned values. In this example, the ELP module 506 uses the information to select a revised predicted business and general location. For example, the ELP module 506 uses address information associated with each of the meeting attendees to determine a general geographic area that is convenient for all attendees (e.g. a center of gravity for the attendees). As another example, the ELP module 506 can employ geographic clustering analysis to identify a predicted general geographic location for the meeting. In this example, the ELP module 506 can determine that four attendees live in San Jose and one attendee lives in Mountain view. The ELP module 506 can then identify San Jose as a predicted general location since four of the meeting attendees are clustered in or near San Jose and only one attendee is not located in San Jose.

As another example, the ELP module 506 can determine that half of the attendees live in Milwaukee, Wis. and half of the attendees live in Chicago, IL and suggest Racine, Wis. as a general location that is generally equidistant from the attendees. In some implementations, the ELP module 506 uses event history information to select a predicted general location. For example, event history information can indicate that meetings that involve all of the attendees usually occur in the Wicker Park neighborhood of Chicago. The ELP module 506 can select Wicker Park as a predicted general location.

In some implementations, the ELP module 506 can determine that the meeting is a telephone conference if locations or addresses associated with two or more of the meeting attendees are above a specified distance away from each other. For example, if the ELP module 506 identifies that two meeting attendees are associated with addresses that are over 50 miles away, the ELP module 506 can determine that the meeting is a telephone conference and identify a predicted general location (or specific location) of “telephone conference.” Continuing with this example, the ELP module 506 may further identify a predicted value of a specific location field or a description field as being a telephone conference dial in number used by the event creator. The dial in number information can be identified based on user profile information or event history information associated with the event creator. In some implementations, the ELP module 506 may predict that the meeting is a telephone conference, but that some of the attendees who are located near each other may still wish to meet in person. For example, the ELP module 506 can generate a predicted value for the specific location field of “Conference Room A7” and a predicted value for the event description field that includes conference call dial in information associated with the event creator.

The ELP module 506 can additionally use the event history information and location information to select a predicted specific location or predicted business location. For example, if four of the five attendees work in the same building, the ELP module 506 can identify a conference room in that building as the predicted specific location. As another example, if three of the five meeting attendees usually meet at Jerry's Restaurant, the ELP module 506 can select Jerry's Restaurant as a predicted specific/business location. As another example, the ELP module 506 can perform a web search, or access the local business directory 512 in order to identify businesses located in the predicted general location. Following the example above where the general predicted location is Racine, Wis., the ELP module 506 can access local business directory information for Racine to identify restaurants with meeting rooms or restaurants that match preferred cuisine styles of the attendees as indicated by the event history information or other user profile information.

The ELP module 506 provides the revised predicted business and general location to the calendar server 504 which provides the values to the front end 502 for presentation to the meeting host. For example, the front end 502 presents the new values for predicted business and predicted general location by displaying the values in associated fields of the calendar application. In some implementations, the ELP module 506 provides more than one predicted value for a given calendar application field. In such implementations, the front end 502 can present a dropdown menu listing the multiple values. The meeting host can then select one of the predicted values, or ignore the predicted values by manually entering a value into the calendar application field or by leaving the calendar application field blank.

Still referring to FIG. 5B, the meeting host enters a time for the meeting which is provided to the calendar server 504 by the front end 502. The calendar server 504 then provides the indicated time to the ELP module 506 for use in determining future predicted values for calendar application fields. The ELP module 506 can use the time to predict an event type. For example, if the meeting time is 12:00-1:00, the ELP module 506 can predict that the event type is lunch. As another example, if the meeting time is 6:00-7:30 and the event title for the event is “hungry?”, the ELP module 506 can predict that the event type is dinner. As another example, if the meeting time is 5:00-7:00 on a Friday, the ELP module 506 can use event history information for the attendees to determine that a majority of the attendees usually attend a happy hour on Friday's from 5:00-7:00. The ELP module 506 then identifies the event type as happy hour. In some implementations, the ELP module 506 uses the time to determine an updated predicted general location. For example, if the time is during the day, the ELP module 506 can identify a location that is equidistant from the work addresses of the attendees as the predicted general location. As another example, if the time is at night, the ELP module 506 can identify a location that is equidistant from the home addresses of the attendees as the predicted general location.

The ELP module 506 provides the predicted event type and general location as well as the event history information to the ELR module 508 to allow the ELR module 508 to identify one or more potential predicted businesses for the meeting. In some implementations, the ELP module 506 can also provide the event title to the ELR module 508. In some implementations, the ELR module 508 identifies one or more keywords to be used as search terms using the provided information. For example, if the event type is lunch, the ELR module 508 can identify a keyword of “restaurant.” If the event type is lunch and event history information indicates that a plurality of the attendees have a preference for Chinese food, the ELR module 508 can identify “Chinese restaurant” as a keyword. As another example, if the event type is happy hour, the ELR module 508 can identify “bar,” “nightclub,” “happy hour special,” or “drink special” as keywords. The ELR module 508 can then provide the keywords and general location to the local business directory 512 which can use the information to identify relevant businesses. In some implementations, the ELR module 508 does not derive keywords using the provided information. As shown in the example, the ELR module 508 can provide the predicted event type and general location directly to the local business directory 512.

The local business directory 512 returns suggested businesses that are relevant to the information provided by the ELR module 508. For example, if an event type of “lunch” is provided, the local business directory 512 returns information for lunch spots located within or near the general location. As another example, if the event type is “gym,” the local business directory 512 returns results for gyms and fitness clubs located within or near the general location. In some implementations, the local business directory 512 provides additional information associated with identified businesses that can be used by the ELR module 508 to rank the potential specific locations and select the highest ranked potential specific locations as suggested specific locations. This information can include business category, business description information, customer rating information, customer reviews, and availability information.

The ELR module 508 can assign ratings to each of the results returned by the local business directory 512 using this business information as well as the event history information. For example, event history information can indicate that several of the attendees are vegetarians, the ELR module 508 can use menu information associated with businesses returned by the local business directory 512 to identify restaurants with vegetarian friendly menus. The ELR module 508 can then assign higher ratings to the identified restaurants.

The ELR module 508 additionally provides information to the ad server 514 to allow the ad server 514 to identify one or more advertisements, or sponsored listings in association with the meeting. In some implementations, the ELR module 508 can derive keywords as described above and provide the keywords to the ad server 514. In other implementations, the ELR module 508 does not derive keywords and simply provides received information associated with the meeting to the ad server 514. For example, as shown in FIG. 5B, the ELR module 508 provides the predicted event type and general location to the ad server 514. The ad server 514 uses this information to identify one or more sponsored listings and returns information associated with the sponsored listings to the ELR module 508.

The ELR module 508 provides business names and related information (e.g. addresses, ratings, customer reviews, etc.) to the ELP module 506. In some implementations the ELR module 508 indicates which businesses are sponsored listings. The ELP module 506 then selects one or more predicted businesses from the list of businesses provided by the ELR module 508. In some implementations, the ELP module 506 may also identify one or more businesses or specific locations that are not indicated by the ELR module 508, for example, by using event history information. The ELP module 506 may use rating information and other information associated with the returned businesses to identify one or more predicted businesses. For example, the ELP module 506 can select one sponsored business (as provided by the ad server 514) and two non-sponsored businesses having the highest ratings. The ELP module 506 returns the identified predicted businesses and the updated predicted general location to the calendar server 504 which provides the values to the front end 502 for presentation to the meeting host.

Still referring to FIG. 5B, the meeting host can elect to select or ignore any of the suggested values (e.g. the predicted business and predicted general location). In some situations, the meeting host continues to provide information by populating additional fields of the calendar application. In the example shown, the meeting host types information into a description field. For example, the meeting host can enter a description of “I'm feeling like sushi.” The front end 502 provides the description entered by the meeting host to the calendar server 504 which provides the description to the ELP module 506. The ELP module 506 uses the description to identify new predicted business and general location values. For example, the ELP module 506 identifies the word “sushi” in the description of “I'm feeling like sushi” and uses this information to select sushi and Japanese restaurants from the list of businesses previously provided by the ELR module 508. As another example, the meeting host enters a description of “let's hit the beach” which the ELP module 506 uses to identify an updated general location. In this example, the ELP module 506 identifies a beach that is located near addresses associated with the attendees. The ELP module 506 can then identify businesses located near the beach.

In some implementations, the ELP module 506 provides the description to the ELR module 508 to allow the ELR module 508 to identify additional business listings and advertisements in association with the meeting. Following the example where the description is “I'm feeling like sushi,” the ELR module 508 can provide a general location received from the ELP module 506 and a keyword of “sushi” to the local business directory 512 and the local business directory 512 returns listings for sushi and Japanese restaurants in or near the identified general location. The ELR module 508 additionally supplies the above information to the ad server 514 to allow the ad server 514 to identify one or more advertisements or sponsored listings to return to the ELR module 508. The ELR module 508 can assign ratings to the returned businesses as described above and then provide this information to the ELP module 506.

The ELP module 506 selects business listings and sponsored listings provided by the ELR module 508 as described above and provides the new predicted business listings and predicted general location to the calendar server 504 which provides the information to the front end 502 for presentation to the meeting host. The meeting host can elect to select or ignore any of the suggested values (e.g. the predicted business and predicted general location). In some situations, the meeting host continues to provide information by populating additional fields of the calendar application. In the example shown, the meeting host enters a business query, for example, by typing the query in a business field or specific location field displayed by the calendar application. The front end 502 sends the business query to the calendar server 504 which provides the business query to the ELP module 506.

The ELP module 506 uses the received business query to further refine predicted business and location values. For example, the meeting host enters a query of “dance clubs.” The ELP module 506 can use the query to identify dance clubs from a list of businesses previously provided by the ELR module 508. As another example, the meeting host enters a business query of “movie theater.” The ELP module 506 provides the business query to the ELR module 508. The ELR module 508 provides the business query and general location information to the local business directory 512 and the ad server 514 in order to receive business listings and sponsored listings that are relevant to the business query. In this example, the local business directory 512 can return listings for movie theaters and related information such as movie titles, times, ratings, price, and ticket availability. The ad server 514 can additionally return sponsored listings or advertisements for particular movie theaters or movies. The sponsored listings or advertisements returned by the ad server 514 can also include related information such as movie titles, times, ratings, price and ticket availability.

The ELR module 508 can apply ratings to the returned listings as described above and provide the information to the ELP module 506. The ELP module 506 then selects one or more sponsored and/or non-sponsored listings as predicted businesses and provides the predicted businesses to the calendar server 504 for delivery to the front end 502 and presentation to the meeting host. In some implementations, the ELP module 506 returns provides additional information associated with the predicted businesses. For example, where the business query is “movie theater,” the ELP module 506 can provide the movie title, time, rating, price, and ticket availability information associated with each predicted business. This information can then be displayed to the user by the front end 502.

Still referring to FIG. 5B, the meeting host can indicate a business by either selecting a business from the list of predicted businesses or by manually entering a business. For example, the front end 502 can display a dropdown menu listing Michael's Theater, Star 5 Theater, and Action Theaters 7 as results for a business query of “movie theater.” The dropdown menu can additionally include a sponsored listing of “X-men, in theaters now [ad].” The meeting host can select one of the listings in the drop down menu to populate the business field. The front end 502 can then inform the calendar server 504 of the meeting host's selection. The calendar server 504 indicates the selected business to the ELP module 506 which returns an acknowledgement. The calendar server 504 then provides an acknowledgement to the front end 502. In some implementations, the meeting can be saved by the meeting host and meeting requests are sent to the invitees. In some implementations, the meeting host elects to close the calendar entry, or the front end 502 determines that the calendar entry is to be closed. A close/save indication is sent to the calendar server 504 by the front end 502. The calendar server 504 then provides a save/close entry screen to the front end 502 for display to the meeting host.

In some implementations, the actions described in relation to FIGS. 5A-5B can be generalized to identify suggested or predicted values for any field for which a user has not indicated a value. In some implementations, suggested or predicted values can also be determined for a field even when a user has already indicated a value for the field. The predicted values can be identified using information supplied by the user in any of the calendar application fields or by heuristic or historic data associated with the user or any of the meeting attendees. For example, history information associated with an invitee can indicate that the invitee had given a certain restaurant within a predicted general location a five star rating. This restaurant can be given a higher rating making it more likely to be selected as a predicted business. As another example, user profile information for an invitee can indicate a preference for higher end restaurants. The user can supply information on which the system can base predictions using any of the fields displayed by the calendar application. For example, the user can start by entering a value of “Ithaca, N.Y.” into the location field. As another example, the user can start by entering a description of “ski trip.” The system can then attempt to populate the location field with the location of a ski mountain located near the user, or a ski mountain that is frequented by the user. The system can additionally suggest invitees for the meeting that have accompanied the user on past ski trips, based on historic information.

The system can employ various intelligent techniques to generate suggestions for field values. For example, machine learning can be employed in order to increase the accuracy of predicted field values as the calendar application is used. In some implementations, the system can employ a Markov model for predicting field values.

For example, a particular event creator (e.g. a meeting host) can be associated with a set of probability matrices P(k), where k is the number of fields displayed by the calendar application. Each row i of every matrix corresponds to a particular value (including Blank) for each field. For example, the creator fills out only the Event Title field and provides a value of “Dinner”. This will indicate the row for which the field Event Title has value Dinner, and all other fields have value Blank. At any given time the number of rows is the product of the number of possible values for each field. For example, the calendar application can include two fields of “invitees” and “time.” In this example, suppose the possible values for invitees is limited to “Jeff,” “John,” and “Greg” and that the value for time is limited to hours only. This gives a total of 3 possible values for the invitees field and 24 possible values for the time field. Therefore the number of rows in this example is 72 (3×24).

Continuing with this example, a field k of the calendar application is associated with a matrix P(k) which predicts the value of field k. In this example, let the initial value of field k be Blank. (If the user has already entered a value for field k, i.e., the value of field k is not Blank, P(k) can be ignored.) Each column j of the matrix P(k) corresponds to a particular value for field k. The value of P(k)[i, j] is the probability that given a set of input values corresponding to row i, the predicted value for field k corresponds to the value associated with column j. For example, suppose field k is the Invitee field, which is currently Blank, and the only other possible values for it are Alice, Bob and Carol. The event creator has entered only a value of “Dinner” for the value of the Event Title field, with all other values Blank. This combination of values for the fields corresponds to column i of the matrix P(k). In this example, the cell P(k)[i, j] represents the probability that Invitee j will be added to this calendar event. For example, P(k)[i, Alice]=0.3, P(k)[i, Bob]=0.7, and P(k)[i, Carol]=0.0 reflect a prediction by the system that the event creator will most likely invite Bob, possibly invite Alice, and will not invite Carol for an event having the title “Dinner”.

The prediction algorithm takes as input the row i corresponding to the current set of field values at a particular time, and for each Blank field returns a set of probabilities for each value that the field can take. In general, probabilities in the matrices P(k) can be derived from frequency counts in the event creator and invitee histories as well as from user profile data associated with the event creator and invitees. For example, suppose the event creator is Susan, and Susan's history has 10 entries, where 7 entries have Bob as an invitee and 3 have Alice. The Invitee probabilities will be P(k)[i, Alice]=0.3, P(k)[i, Bob]=0.7, and P(k)[i, Carol]=0.0. The frequencies in the event creator history are updated each time event creator saves a calendar entry. When the event creator saves a calendar entry, counts for all the non-Blank values in the fields for that entry can be updated. For the history associated with a particular invitee, the counts can be updated each time the invitee accepts an event or each time an event notice or meeting request is received from the invitee.

In some implementations, continuous machine learning is employed in order to increase the accuracy of predicted field values over time. For example, as more and more event history information is collected by the system in association with the event creator and various past meeting invitees, probabilities for potential field values can be adjusted. For example, probabilities can be adjusted for options for an Event Title field that have been previously presented to the event creator. When the user selects a particular option, the probability of that option being presented as a predicted value in the future is increased. When the user ignores a suggested field value, the probability of that option being presented as a predicted value in the future can be decreased. In some implementations, during a machine learning phase, the system may present previously unused values or previously under-used values in order to obtain user feedback for the options that can be used in determining future probabilities for the values.

In some instances there may not be enough available event history information to reliably use values identified using one or more probability matrices as described above. For instance, the event creator may be a new user of the calendar application and little or no event history information for the event creator may be available. In such instances, a variety of heuristics can be used to populate one or more probability matrices. For example, suppose a Host name field has a value of Susan, and an Invitee field has values of Alice and Bob. In this example, the system attempts to predict a value for a Location field; however, there are no prior meetings or events for which a value is recorded for the location field. In such cases, a probability heuristic can be used to predict a value for the Location field. For example, probability p0 is assigned to a location associated with Susan, probability p1 is assigned to a location associated with Alice, probability p2 is assigned to a location associated with Bob, and probability p3 is assigned to a location that is roughly equidistant from locations associated with all three attendees. The values for these probabilities pi can be derived from general historic data (e.g. in this company 3-person meetings are typically held in the Host's office), offline statistical analysis of all Location values in histories for all events (e.g., 80% of the time any event location is the Host's office), offline analysis of the histories for a particular participant (e.g., even though historic values for the Location field for Susan's meetings with Alice and Bob are unavailable, 60% of all of Susan's meetings are held in conference room H), or additional available data. For example, a business directory such as the local business directory 512 can be used to identify predicted values for fields based on known values for other fields as described above. Heuristics can be suggested to the event creator by the system using a user interface. The event creator can edit and select suggested values for one or more fields using the interface. Further, probabilities obtained using heuristics can be combined with the probabilities predicted by frequency counts in the Host and Invitee event history information. In some implementations, an equation can be used to combine heuristic based probabilities with historic information based probabilities. For example the over all probability can be calculated using the following formula:

probability P(k)[i, j]=alpha*Prob(Heuristic)+(1−alpha)*Prob(History)

In this formula, alpha is a real number between 0 and 1 inclusive and represents a weighting factor, Prob(Heuristic) is the value predicted using heuristic information, and Prob(History) is the value predicted by using event history information associated with the attendees. In some implementations, as more event history information becomes available through subsequent use of the calendar application by the event creator, the value of alpha can decrease stepwise from 1 to 0 over time.

In some alternate implementations, the system can employ a graphic based intelligent technique (e.g. a Bayesian model) for generating predicted field values. For example, a Bayseian Network per-user graphical model can be employed where each node within the graphical model represents a field of the calendar application, with associated probability distributions for each value in the field. Links between the nodes can represent dependence between fields. In some implementations, absence of a link between two nodes can indicate that the fields associated with the two nodes are independent from each other. A joint probability distribution for a particular value for any field that needs to be predicted (e.g. a blank field) can be calculated using the values for the known fields. This method can be particularly helpful for a general case where any field can be the target for prediction by the system.

As another example, a per-user Support Vector Machine (SVM) model can be employed in which a per-user SVM is used for each field that is to be predicted. Numerous techniques based on SVM can be applied in such cases. One complication for applying SVM to the calendar application is that unlike canonical applications of SVM, a particular item in the training history may have multiple labels. For example, in a canonical application of an SVM model, a system will attempt to classify an object (e.g. an email) as being in a particular category (e.g. spam or nonspam). Therefore an input vector for an email object could be <from:badguy subject:free> with a label +1 indicating spam and −1 indicating not spam. However in a calendar application the same input vector can have multiple different labels. For example, the field values <Susan, Alice, 1 pm> could have instances with 3 different labels (say 8 labeled meeting, 2 labeled lunch and 0 labeled chat). In this specific example, it could be sufficient to pick the various labels from history and rank them in order of the occurrence frequency, and pick the top ranked suggested values to show in the suggest box. However, more accurate predictions can be made by employing machine learning techniques. For example, by using genre classifiers (e.g. multi-label classifiers or ranking SVM), where a single instance can belong to multiple classification categories.

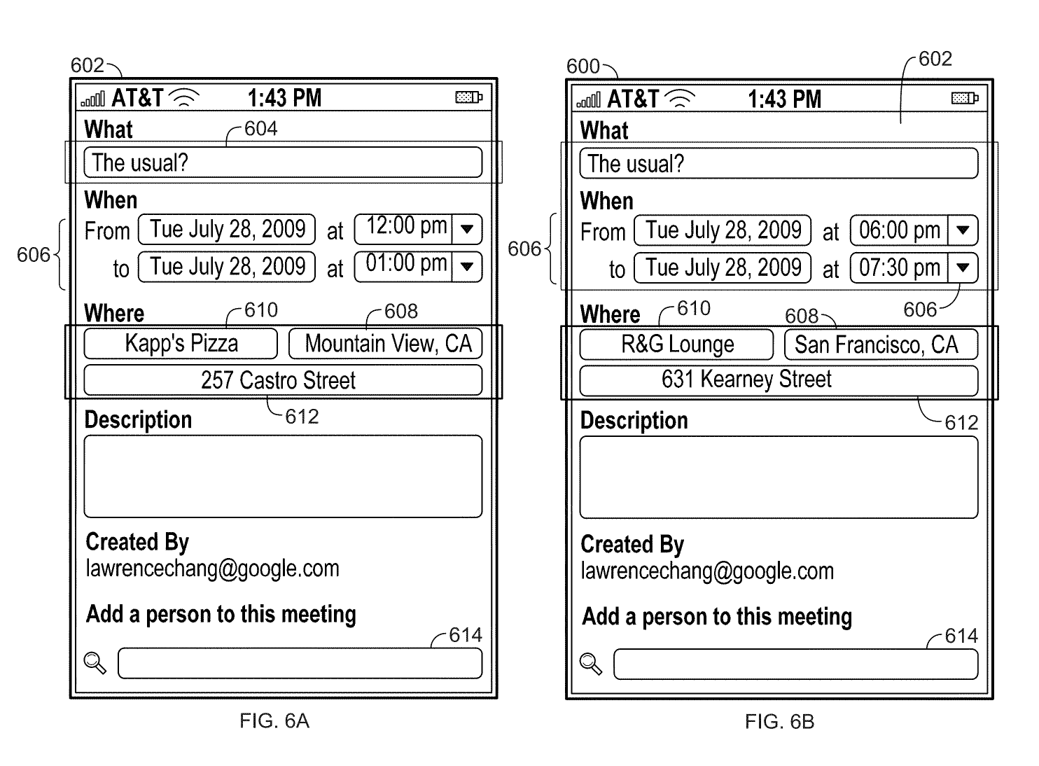

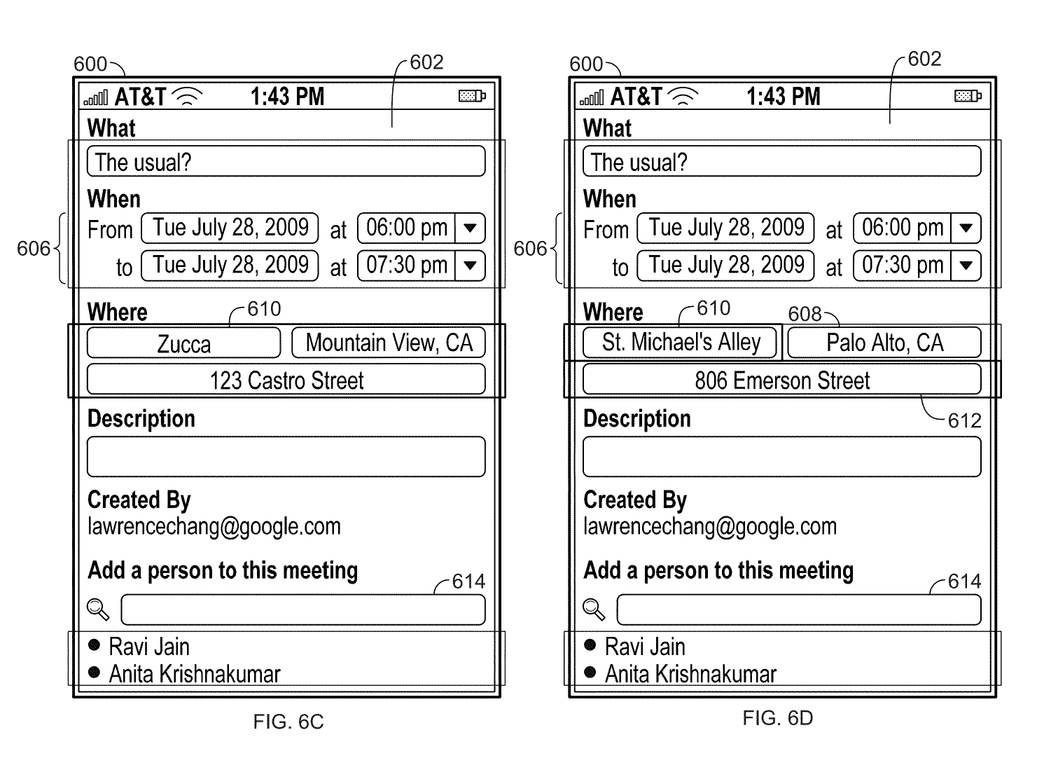

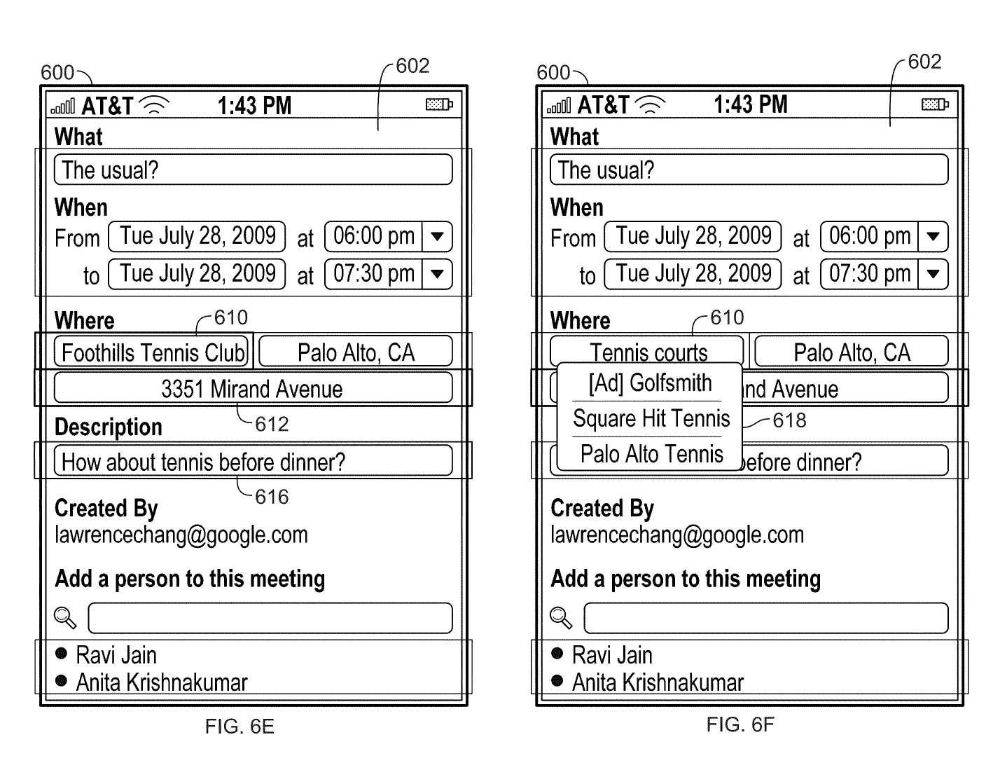

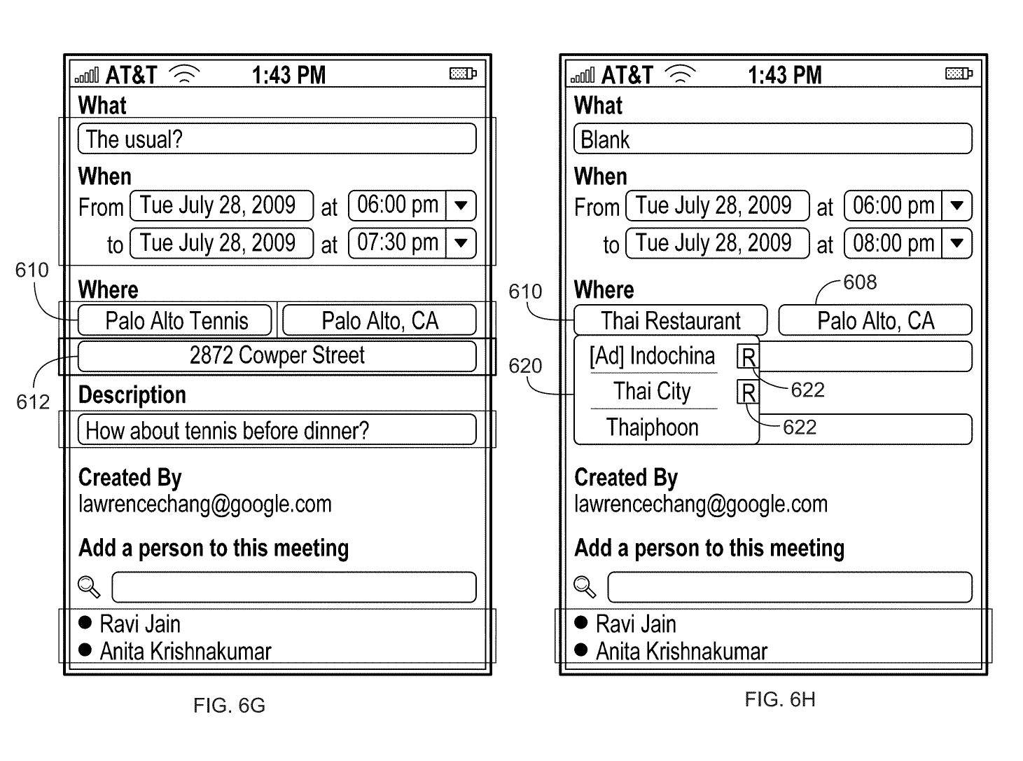

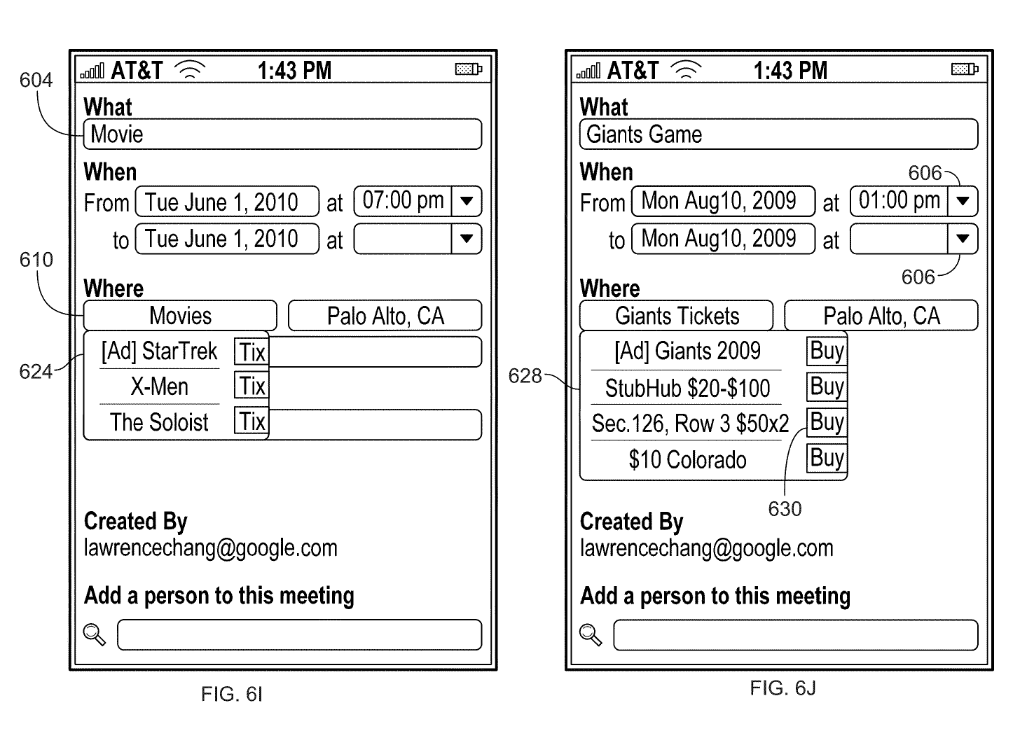

FIGS. 6A-6J show example screen shots of a mobile computing device running a calendar application 600; however, it should be understood that the calendar application 600 can run on computing devices other than mobile devices, such as desktop computer, laptop computers, and web enabled TVs. The screen shots show various interactions performed with a calendar event entry form 602 of the calendar application 600. The calendar event entry form 602 includes multiple fields that can be populated by a user while creating a calendar event. For example, the user can populate fields using a keyboard or touch screen. As another example, the user can populate the fields using voice dictation.

The fields allow the user to define parameters associated with the calendar event. Additionally, the fields allow a system to present predicted values to the user. Referring to the example shown in FIG. 6A, the user has entered a value of “The usual?” into an event header field 604. Event time fields 606 of the calendar event entry form 602 are initially populated with a default time value of the current days date (in this example, Jul. 28, 2009) and a default time of 12:00 pm to 1:00 pm. At this stage of entering information into the calendar event entry form 602, the user has not provided values for any of the remaining fields. In the example shown, a system has provided predicted values for some of the fields left blank by the user. Some of the blank fields of the calendar event entry form 602 are automatically populated with the predicted values provided by the system. For example, a predicted value of “Mountain View, Calif.” is displayed in a general location field 608 of the calendar event entry form 602. In this example, the predicted value for the general location field 608 may be based on user profile data associated with the user. For example, the system can identify a work address associated with the user since the current values shown in the event time fields 606 indicate that the calendar event is to occur during the day on a weekday. The system can identify that the user's work address is located in Mountain View, Calif. and display a predicted value of Mountain View, Calif. in the general location field 608.

Still referring to the example shown, the system can further determine that a calendar event occurring from 12:00 pm-1:00 pm is most likely lunch. A business field 610 of the calendar event entry form 602 can be automatically populated based on this information. For example, it can then be determined, using event history information associated with the user, that the most frequent location for lunch events initiated by the user is Kapp's Pizza. The predicted value of Kapp's Pizza is presented to the user in the business field 610 of the calendar event entry form 602. The system additionally identifies an address for Kapp's Pizza, for example, using address information obtained from past calendar events or by accessing a business directory. The calendar application 600 displays the address for Kapp's Pizza in an address field 612 as a predicted value.

Referring now to FIG. 6B, the user continues to add information into the calendar event entry form 602. In the example shown, she specifies time values in the event time fields 606 of 6:00 pm to 7:30 pm on Jul. 28, 2009. The predicted values for the remaining fields for which the user has not entered a value can be revised using the new information provided by the user and one or more fields of the calendar event entry form 602 are automatically populated using these revised values. For example, the system identifies a calendar event that occurs from 6:00 pm to 7:30 pm as most likely being dinner. The system can further determine that the user will be done with work by 6:00 pm, and identify a home address associated with the user. In the example shown, the system identifies the user's home address as being located in San Francisco and provides a predicted value of “San Francisco, Calif.” for display in the general location field 608. The system can further identify R & G Lounge as a restaurant that most frequently occurs as a business for weekday dinner events in San Francisco, Calif. that are initiated by the user. The predicted value of “R & G Lounge” is displayed to the user in the business field 610. The system identifies the address of R & G Lounge and populates the address field 612 with the address as a predicted value for the address field 612. In some implementations, the user can indicate that one or more of the predicted values are to be used by selecting one or more of the predicted values. For example, the user can select the general location field 608 in order to “keep” the value of San Francisco, Calif. for the general location field 608. In some such implementations, the system can use the predicted values selected by the user for predicting future values for other fields of the calendar event entry form 602.

Referring now to FIG. 6C, the user indicates invitees for the calendar event using an invitee field 614. The user indicates that Ravi and Anita are invitees for the calendar event. The invitees indicated by the user are then displayed by the calendar event entry form 602. The system identifies information associated with the invitees entered by the user in order to further revise predicted values for other fields of the calendar event entry form 602. For example, the system can identify addresses for each of the event attendees and use this information to determine a geographic center of gravity for the three meeting attendees. In the example shown, the system identifies a new general location of Mountain View Calif. For example, the system may identify that the user lives in San Francisco, Ravi lives in San Jose, and Anita lives in Mountain View. The system can then determine that Mountain View is a central location for all three event attendees. The predicted value of “Mountain View, Calif.” is displayed to the user in the general location field 608. In some implementations, the system uses geographic clustering analysis based on address or location information associated with the attendees to determine a predicted general location for the calendar event. For example, the system may be able to access GPS information for each of the attendees in order to determine near real time locations for each of the meeting attendees. In this example, the system can identify that 7 out of 9 meeting attendees are currently in the Union Square neighborhood of New York. In some implementations, the system can ignore the locations of the other two attendees, or apply less weight to the locations of the other two attendees. The system can identify Union Square as a predicted general location since 7 of the 9 attendees are currently clustered in Union Square.

Referring back to the example shown, the system further identifies a suggested business value of “Zucca.” For example, the system can identify Zucca as a business most often used as a business for events involving Ravi, Anita, and the user. As another example, the system can use the previously predicted event type of dinner to identify a restaurant in Mountain View, Calif. using a business directory. The system can identify Zucca as a top rated restaurant that matches eating preferences specified in user profile information associated with the attendees. The system identifies an address for Zucca which is presented to the user as a predicted value in the address field 612.

Referring now to FIG. 6D, the user continues to add information to the calendar event entry form 602 by specifying a general location of “Palo Alto, Calif.” in the general location field 608. For example, the user can type the general location into the general location field 608. As another example, the user can use mapping functionality of the calendar application 600 or a mapping application of the mobile device to indicate a general location on a map. The system then populates the general location field 608 with the general location indicated by the user using the map. The system uses the new value for general location specified by the user to revise a predicted value for the business field. In this example, the system identifies St. Michael's Alley as a restaurant for the current calendar event and automatically populates the business field 610 with this predicted value. In some implementations, the system uses event history information, business directory information, or a combination of both as described above in order to identify St. Michael's Alley as a predicted value for the business field 610. The calendar event entry form 602 displays the address of St. Michael's Alley as a predicted value for the address field 612.

Referring to FIG. 6E, the user enters a value of “How about tennis before dinner?” into a description field 616 of the calendar event entry form 602. In this example, the system can identify the words “tennis” and “dinner” in the description as being relevant for determining a predicted value for the business field 610. The system can access a business directory to identify tennis-related restaurants, or tennis clubs that include restaurants or food service that are located in or near Palo Alto, Calif. The system can then identify a top rated suggested value to display to the user. For example, businesses located closer to the center of Palo Alto may be given higher ratings. As another example, a tennis club to which one of the attendees belongs can be given a higher rating. In the example shown, Foothills Tennis Club is identified as a predicted value for the business field 610 and is displayed to the user in the business field 610. The address for the Foothills Tennis Club is presented to the user in the address field 612.

Referring to FIG. 6F, the user enters a business query into the calendar event entry form 602 using the business field 610. The user enters a query of “Tennis courts.” The calendar application 600 displays a list 618 of suggested values in response to the query entered by the user. For example, the system may access a business directory or search engine to identify businesses located in or near Palo Alto, Calif. using “tennis courts” as a search term. In some implementations, the system additionally accesses an advertisement server in order to receive one or more advertisements for presentation to the user that are relevant to the user's search query. In the example shown, the list 618 includes an advertisement or sponsored listing of Golfsmith. The advertisement is indicated as an advertisement by the character string “[Ad].”

The list 618 additionally includes predicted values of Square Hit Tennis, and Palo Alto Tennis that have been identified as being businesses in Palo Alto that are relevant to the user's search query of “Tennis courts.” In some implementations, the user can select one of the suggested values from the list 618 in order to populate the business field 610 with the suggested value. In some implementations, the user can ignore the suggested values by manually entering a different value into the business field 610. In some implementations, the user can select the business field 610 or an icon in order to cause the system to rerun a search using the business query entered by the user and present different suggested values.

Referring to FIG. 6G, the user selects “Palo Alto Tennis” from the list 618 which causes the calendar event entry form 602 to populate the business field 610 with the value “Palo Alto Tennis.” The address field 612 is then automatically populated with the address for Palo Alto Tennis. In some implementations, the user elects to save the calendar event and send event invites to the indicated invitees. In some implementations, the information included in the calendar event is stored as event history information and used in determining predicted field values for future calendar events.

FIG. 6H shows the calendar event entry form 602 of FIGS. 6A-6G in which the user has entered a business query of “Thai restaurant” into the business field 610. For example, the screen shot shown in FIG. 6H can follow the screen shot shown in FIG. 6D where the user has indicated a general location of the Palo Alto, Calif. in the general location field 608. In the example shown in FIG. 6H, the calendar application 600 displays a list 620 of suggested search results in response to the business query entered by the user. In this example, the list 620 includes a sponsored listing of Indochine. The listing is indicated as being a sponsored listing by the character string “[Ad].” The list 620 additionally includes results for Thai City and Thaiphoon. In the example shown, the list 620 includes indicators 622 to indicate if reservations can be made for any of the suggested restaurants. The indicators 622 indicate that reservations are available for the time indicated in the event time fields 606 for Indochine and Thai City, but that no reservations are available for the time indicated in the event time fields 606 for Thaiphoon. In some implementations, the user can select one of the indicators 622 in order to make dinner reservations. For example, selecting the indicator 622 next to Thai City can cause a web browser to display a web page where the user can make a reservation for Thai City. In some implementations, one or more fields of the reservation web page can be automatically populated by the calendar application 600 based on information contained in the fields of the calendar event entry form 602. As another example, selecting the indicator next to Indochine can cause the calendar application 600 or a related application to automatically generate a reservation request and provide the reservation request to a restaurant reservation service. In this example, the calendar application 600 can create a reservation request for three people (based on the number of event attendees) for 6:00 pm on Jul. 28, 2009 and provide the request to a restaurant reservation service.

Referring to FIG. 6I, the user has entered an event header of “Movie” into the event header field 604 and has entered a business query of “movies” into the business field 610. In response, the calendar event entry form 602 displays a list 624 of suggested movies. The list 624 includes a sponsored listing of Star Trek as indicated by the character string “[Ad],” and non-sponsored listings of X-Men and The Soloist. In some implementations, the list 624 includes indicators 626 to indicate if tickets are available for the suggested movies. In the example shown, the indicators 626 indicate that tickets are available for the time specified by the user in the event time fields 606 for Star Trek and X-Men, but that tickets are not available for the Soloist in Palo Alto at the specified time. In some implementations, the user can select an indicator 626 in order to purchase tickets for the associated movie. For example, the user can select the indicator 626 next to the movie Star Trek to cause a web browser to display a web page where the user can purchase tickets. In some implementations, one or more fields of the movie ticket purchasing web site can be automatically populated by the calendar application 600.

Referring to FIG. 6J, the user has entered an event header of “Giants Game” into the event header field 604 and has indicated a business query of “Giants tickets” using the business field 610. The system can use the indicated general location of Palo Alto, Calif. to determine that the user is most likely referring to the San Francisco Giants baseball team rather than the New York Giants football team or the Vancouver Giants junior ice hockey team. In response, the calendar event entry form 602 displays a list 628 of predicted values. In the example shown, the list 628 includes a sponsored listing of “Giants 2009.” In some implementations, selecting the listing of “Giants 2009” may cause a web page for the San Francisco Giants or web page where the user can purchase San Francisco Giants merchandise to open in a web browser. The remaining listings of the list 628 can indicate tickets that are available for a game being played by the Giants during the time indicated by the user in the event time fields 606. The list 628 can indicate prices for the available tickets, which team the Giants are playing (e.g. Colorado), or other relevant information (e.g. section 126, row 3). The user can select an indicator 630 next to one of the listings to purchase tickets. For example, selecting the indicator 630 next to the listing of “$10 Colorado” can cause a web page where the user can purchase $10 tickets to the game to be opened in a web browser. As another example, selecting the indicator 630 next to the listing of “$20 Colorado” can allow the user to purchase three $20 tickets (for the three event attendees) to the game. In this example, the calendar application 600 may be able to access stored credit card information for the user in order to make the purchase and indicate that the tickets should be held at will call.

Though not shown in the particular screen shots, various advertisements may be shown to a user when entering information in an appointment form or at other times. Such advertisements may be selected using information that has been entered on the form, such as a meeting topic, or that is derived from information entered on the form, such as a location of a meeting or suggested location of the meeting. As one example, when a user enters a meeting topic of “meeting,” the system may infer an informal meeting, and advertisements for coffee shops may be selected. When a location for the meeting is identified, either manually by the user (e.g., typing a business name to instigate a local search and then selecting the right business form a list of search results) or semi-automatically (e.g., the system identifying locations for the invitees and a central location), various advertisements for coffee shops that are determined to have venues near that location may be served. Thus, perhaps the display would initially show advertisements for all sorts of venues in the area, and the advertisements will be updated once the user provides a topic. Alternatively, if the user provides the topic first, the advertisements may be for particular types of venues around the user's current location (with an assumption that the user will site the meeting near herself), and the advertisements can be updated as invitees are added and new “best” locations for the meeting are determined by the system.

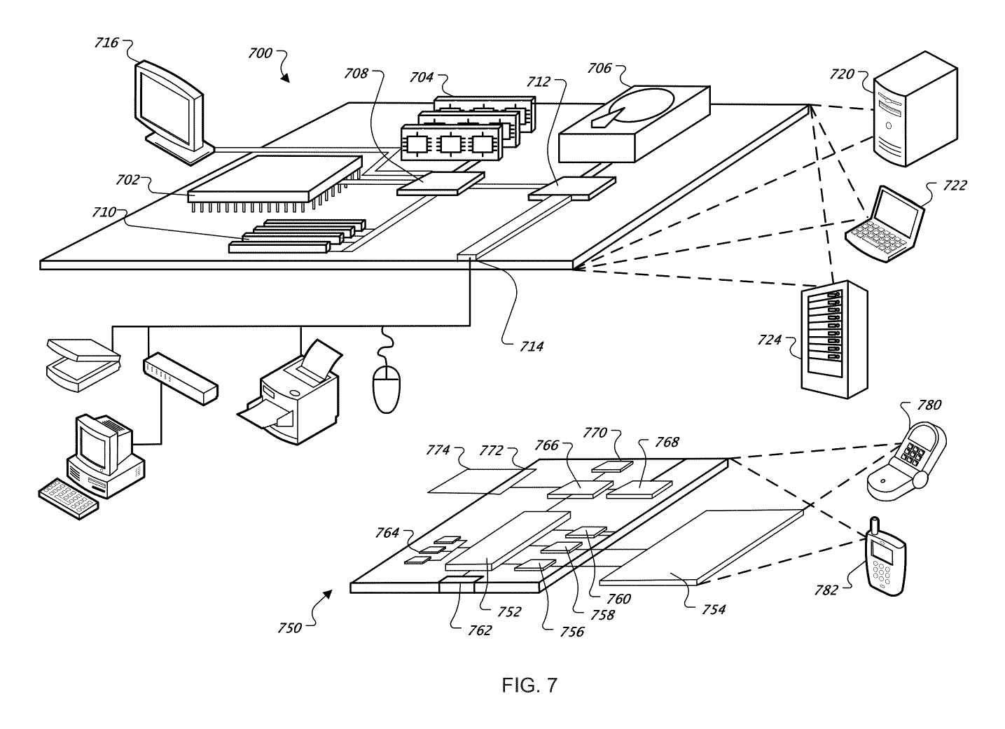

FIG. 7 is a block diagram of computing devices 700, 750 that may be used to implement the systems and methods described in this document, as either a client or as a server or plurality of servers. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a computer-readable medium. In one implementation, the memory 704 is a volatile memory unit or units. In another implementation, the memory 704 is a non-volatile memory unit or units.

The storage device 706 is capable of providing mass storage for the computing device 700. In one implementation, the storage device 706 is a computer-readable medium. In various different implementations, the storage device 706 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 704, the storage device 706, memory on processor 702, or a propagated signal.

The high speed controller 708 manages bandwidth-intensive operations for the computing device 700, while the low speed controller 712 manages lower bandwidth-intensive operations. Such allocation of duties is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, and an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can process instructions for execution within the computing device 750, including instructions stored in the memory 764. The processor may also include separate analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD display or an OLED display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication (e.g., via a docking procedure) or for wireless communication (e.g., via Bluetooth or other such technologies).

The memory 764 stores information within the computing device 750. In one implementation, the memory 764 is a computer-readable medium. In one implementation, the memory 764 is a volatile memory unit or units. In another implementation, the memory 764 is a non-volatile memory unit or units. Expansion memory 774 may also be provided and connected to device 750 through expansion interface 772, which may include, for example, a SIMM card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, memory on processor 752, or a propagated signal.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS receiver module 770 may provide additional wireless data to device 750, which may be used as appropriate by applications running on device 750.

Device 750 may also communicate audibly using audio codec 760, which may receive spoken information from a user and convert it to usable digital information. Audio codex 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the scheduling systems and methods have been described, it should be recognized that numerous other applications are contemplated. Accordingly, other embodiments are within the scope of the following claims.

1-13. (canceled)

14. A computer-implemented method comprising:
receiving, at a computer server system, information that relates to an event and that has been entered on a scheduling entry form by a user of a computing device, the information identifying one or more invitees for the event;
determining an event location based at least on the received information that relates to the event;
selecting, with the computer server system and based at least on one of the received information that relates to the event and the event location, one or more advertisements that are determined to likely be of interest to at least one of the one or more invitees upon completion of the event; and
identifying that the event is completed, and in response, providing, to respective computing devices for the at least one of the one or more invitees, computer code for causing the one or more advertisements to be displayed.

15. The computer-implemented method of claim 14, wherein the event location is not provided by the user, wherein determining the event location comprises identifying a location that is common to the one or more invitees for the event.

16. The computer-implemented method of claim 14, wherein selecting the one or more advertisements comprises matching a topic for the event that the user provided to advertising keywords that correspond to candidate advertisements.

17. The computer-implemented method of claim 14, wherein selecting the one or more advertisements comprises determining that at least a first of the invitees has positively rated a location associated with a first of the one or more advertisements.

18. The computer-implemented method of claim 14, further comprising, in response to receiving the information that relates to the event and determining the event location, causing electronic invitations for the event to be sent to the one or more invitees.

19-20. (canceled)

21. The computer-implemented method of claim 14, wherein the one or more advertisements are associated with keywords selected by advertisers who placed the advertisements, wherein selecting the one or more advertisements comprises matching the received information that relates to the event with the keywords selected by the advertisers.

22. (canceled)

23. The computer-implemented method of claim 14, wherein determining the event location comprises using an identified context for the event that indicates the type of event being scheduled and determining that the event location satisfies a criterion associated with the type of event being scheduled.

24. The computer-implemented method of claim 14, wherein the event location is not provided by the user, wherein determining the event location comprises:
determining, based on particular locations associated with the one or more invitees, a plurality of candidate locations;
providing, to the computing device for display to the user, information that characterizes the plurality of candidate locations; and
receiving, from the computing device, data that indicates a selection from user input of the event location from among the plurality of candidate locations.

25-26. (canceled)

27. The computer-implemented method of claim 14, wherein the received information that relates to the event includes the event location, and wherein determining the event location comprises identifying the event location from the received information.

28. The computer-implemented method of claim 14, wherein identifying that the event is completed comprises receiving an indication that the at least one of the one or more invitees has left the event location.

29. A system comprising:
one or more processors; and
one or more computer-readable media having stored thereon instructions that, when executed by the one or more processors, cause performance of operations comprising:
receiving, at the system, information that relates to an event and that has been entered on a scheduling entry form by a user of a computing device, the information identifying one or more invitees for the event;
determining an event location based at least on the received information that relates to the event;
selecting, with the system and based at least on one of the received information that relates to the event and the event location, one or more advertisements that are determined to likely be of interest to at least one of the one or more invitees upon completion of the event; and
identifying that the event is completed, and in response, providing, to respective computing devices for the at least one of the one or more invitees, computer code for causing the one or more advertisements to be displayed.

30. The system of claim 29, wherein the event location is not provided by the user, wherein determining the event location comprises identifying a location that is common to the one or more invitees for the event.

31. The system of claim 29, wherein selecting the one or more advertisements comprises matching a topic for the event that the user provided to advertising keywords that correspond to candidate advertisements.

32. The system of claim 29, wherein selecting the one or more advertisements comprises determining that at least a first of the invitees has positively rated a location associated with a first of the one or more advertisements.

33. The system of claim 29, wherein the operations further comprise, in response to receiving the information that relates to the event and determining the event location, causing electronic invitations for the event to be sent to the one or more invitees.

34. The system of claim 29, wherein the one or more advertisements are associated with keywords selected by advertisers who placed the advertisements, wherein selecting the one or more advertisements comprises matching the received information that relates to the event with the keywords selected by the advertisers.

35. The system of claim 29, wherein determining the event location comprises using an identified context for the event that indicates the type of event being scheduled and determining that the event location satisfies a criterion associated with the type of event being scheduled.

36. The system of 29, wherein the event location is not provided by the user, wherein determining the event location comprises:
determining, based on particular locations associated with the one or more invitees, a plurality of candidate locations;
providing, to the computing device for display to the user, information that characterizes the plurality of candidate locations; and
receiving, from the computing device, data that indicates a selection from user input of the event location from among the plurality of candidate locations.

37. The system of claim 29, wherein the received information that relates to the event includes the event location, and wherein determining the event location comprises identifying the event location from the received information.

38. The system of claim 29, wherein identifying that the event is completed comprises receiving an indication that the at least one of the one or more invitees has left the event location.
